(19) United States
(12) Patent Application Publication
(10) Pub. No.: US 2014/0172731 A1
(43) Pub. Date: Jun. 19, 2014

(54) FLOOR PLAN CREATION AND WORKER ASSIGNMENT

(71) Applicant: CELLCO PARTNERSHIP D/B/A VERIZON WIRELESS, Basking Ridge, NJ (US)

(72) Inventors: Richard J. Ericksen, Kearny, NJ (US); Andrew T. Lapham, Milford, NJ (US); John E. Hyde, Clifton, NJ (US)

(73) Assignee: CELLO PARTNERSHIP d/b/a VERIZON WIRELESS, Basking Ridge, NJ (US)

(21) Appl. No.: 13/719,664

(22) Filed: Dec. 19, 2012

(51) Int. Cl. G06Q 10/10

(52) U.S. Cl. CPC G06Q 10/105
USPC 705/320

(57) ABSTRACT

A device is configured to receive a user request that identifies a floor plan, and to provide the floor plan on a first portion of a user interface. The device is configured to receive, from another device, information that identifies workspaces associated with the floor plan, and to provide, on a second portion of the user interface, one or more workspace objects associated with the workspaces. The device is configured to receive a user selection of a particular workspace object and a portion of the floor plan, and to provide, on the first portion of the user interface associated with the selected portion of the floor plan, a representation of the particular workspace object.

### BACKGROUND

An enterprise may keep track of workers and worker assignments in a variety of ways. For example, an enterprise may assign a worker to an office, a phone number, a mailbox, etc. The enterprise may keep track of events that impact the worker's assignments. For example, a worker may be hired, may leave the enterprise, may move to a new location within the enterprise, may receive a promotion, etc.

### BRIEF DESCRIPTION OF THE DRAWINGS

FIGS. 1A and 1B are diagrams of an overview of an example implementation described herein;

FIG. 2 is a diagram of an example environment in which systems and/or methods described herein may be implemented;

FIG. 3 is a diagram of example components of one or more devices of FIG. 2;

FIG. 4 is a flow chart of an example process for creating or editing a floor plan;

FIGS. 5A-5F are diagrams of example user interfaces for implementing the example process shown in FIG. 4;

FIG. 6 is a flow chart of an example process for associating workers with the floor plan;

FIGS. 7A-7E are diagrams of example user interfaces for implementing the example process shown in FIG. 6;

FIG. 8 is a flow chart of an example process for generating and providing a report associated with the floor plan; and

FIGS. 9A-9C are diagrams of example user interfaces for implementing the example process shown in FIG. 8.

### DETAILED DESCRIPTION OF PREFERRED EMBODIMENTS

The following detailed description of example implementations refers to the accompanying drawings. The same reference numbers in different drawings may identify the same or similar elements.

An enterprise may keep track of workers and worker assignments in a variety of ways. In some enterprises, particularly large enterprises with a large number of workers, it may be difficult to keep track of workers, worker locations, and other information associated with workers. Implementations disclosed herein assist an enterprise in keeping track of workers and worker information, such as worker locations.

As used herein, an enterprise may refer to a business, an organization, a government agency, a company, a firm, a venture, a related group of people, etc. As used herein, a worker may refer to an employee, a contractor, an agent, a laborer, a member, etc., of an enterprise, or any other person that performs work for an enterprise.

As used herein, a floor plan may refer to a diagram (displayed to scale or not to scale) of the arrangement of a floor of a building or a portion of a floor of a building. For example, the floor plan may display an arrangement of workspaces (e.g., rooms, offices, cubicles (cubes), work stations, etc.), hallways, corridors, entrances, exits, etc. associated with the floor of the building. Herein, “floor plan” may be used interchangeably with “space plan.”

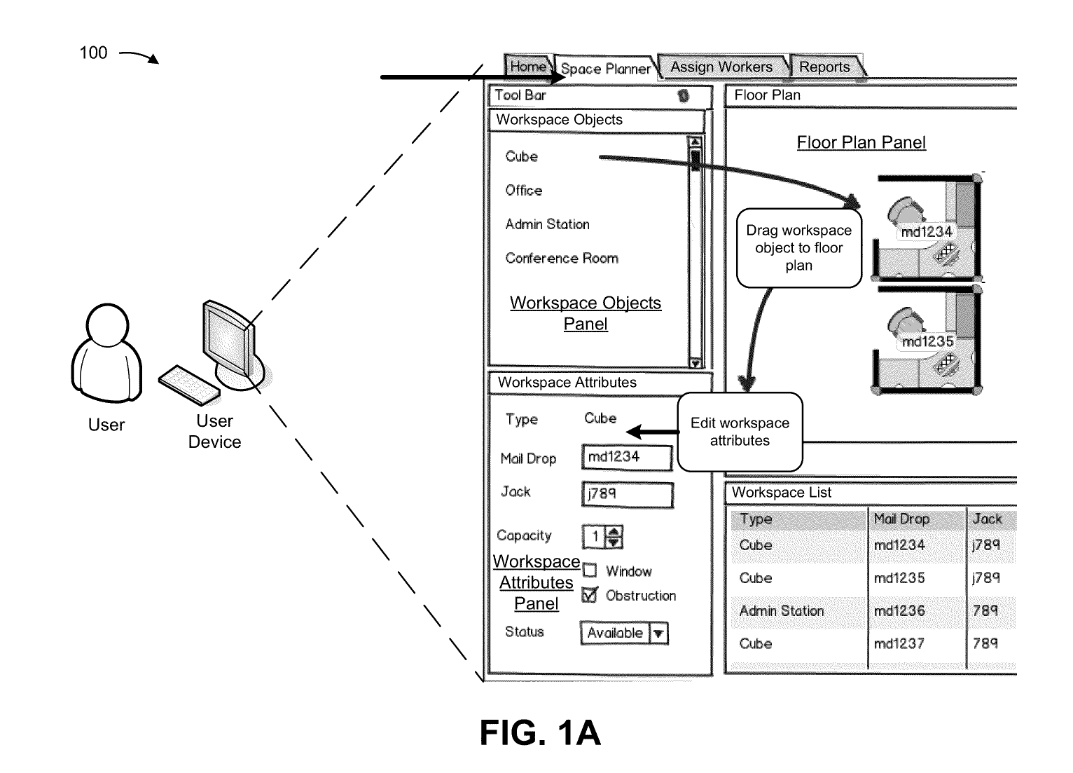

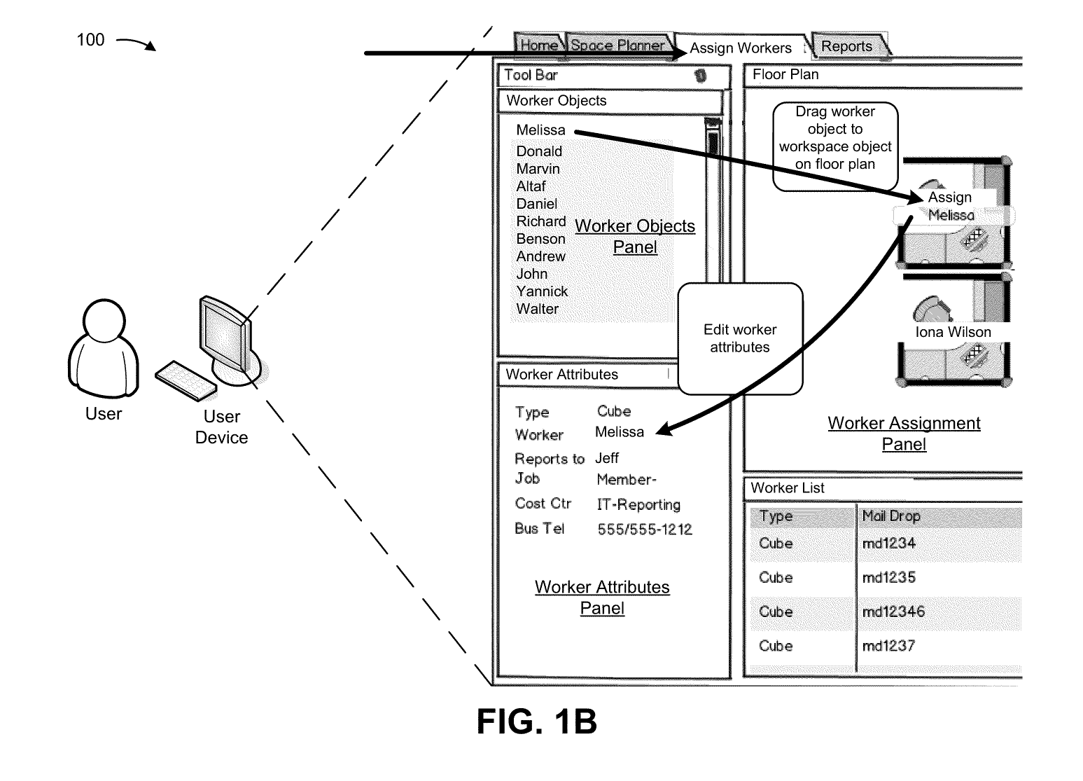

FIGS. 1A and 1B are diagrams of an overview of an example implementation 100 described herein. As shown in FIG. 1A, a user interacting with a user device, such as a desktop computer, may create a floor plan on a user interface displayed by the user device. As shown, the user may navigate to a space planner tab that provides a user interface for laying out a floor plan. The user interface may provide a list of workspace objects in a workspace objects panel. The workspace objects may represent workspaces of an enterprise, such as an office, a cubicle (cube), a work station (e.g., an administration station, such as a reception desk), a conference room, etc. The user interface may also provide a floor plan panel on which the user may create and/or edit the floor plan.

As further shown in FIG. 1A, the user may drag a workspace object from the workspace objects panel to the floor plan panel to lay out the floor plan. For example, a user may drag a cubicle object from the workspace objects panel to the floor plan panel, and the floor plan panel may display a representation of the cubicle (e.g., cubicle md1234, as shown). Additionally, or alternatively, the user may edit workspace attributes associated with the cubicle (e.g., a mailbox associated with the cubicle, a capacity of the cubicle, an availability status of the cubicle, etc.) via a workspace attributes panel provided by the user interface, as shown.

As shown in FIG. 1B, the user may navigate to an assign workers tab that provides a user interface for assigning workers to workspaces. The user interface may provide a list of worker objects in a worker objects panel. The worker objects may represent workers associated with an enterprise. The user interface may also provide a worker assignment panel that displays workspace objects associated with a floor plan.

As further shown in FIG. 1B, the user may drag a worker object from the worker objects panel to a workspace object displayed on the worker assignment panel, to assign a worker to a workspace. For example, the user may drag a worker object representing an employee named Melissa from the worker objects panel to a cubicle displayed on the worker assignment panel, and the worker assignment panel may display an indication that Melissa has been assigned to the cubicle. Additionally, or alternatively, the user may edit worker attributes associated with Melissa (e.g., job title, supervisor, cubicle number, telephone number, etc.) via a worker attributes panel provided by the user interface, as shown. In some implementations, the user device may not permit the user to edit worker attributes via the user interface. For example, the user device may receive the worker attributes from a data structure (e.g., accessible by the user device), or may receive the worker attributes from an administrative device (e.g., a human resources system). In this way, an enterprise user may keep track of workers and information associated with workers.

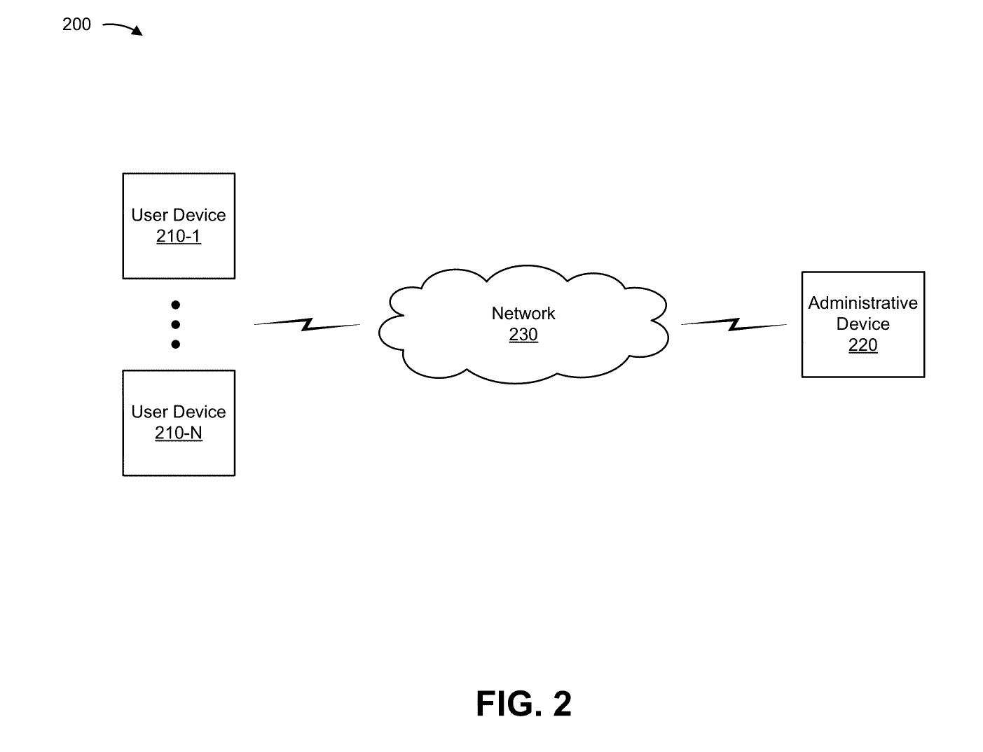

FIG. 2 is a diagram of an example environment 200 in which systems and/or methods described herein may be implemented. As shown in FIG. 2, environment 200 may include one or more user devices 210-1 through 210-N (N≧1) (hereinafter referred to collectively as “user devices 210,” and individually as “user device 210”), an administrative device 220, and a network 230. The devices of environment 200 may interconnect (e.g., via network 230) via wired connections, wireless connections, or a combination of wired and wireless connections.

User device 210 may include a computing device capable of receiving user input and providing a user interface. For example, user device 210 may include a desktop computer, a laptop computer, a tablet computer, a handheld computer, a server, a smart phone, or a similar device. In some implementations, user device 210 may provide a user interface that assists a user in creating and editing a floor plan, and/or assigning workers to workspaces. Additionally, or alternatively, user device 210 may be capable of accessing network 230 and/or communicating with administrative device 220 to determine information to display on the user interface and/or to provide user input to administrative device 220.

Administrative device 220 may include a computing device capable of receiving input and/or communicating with user device 210 (e.g., via network 230). For example, administrative device 220 may include a server, a desktop computer, a laptop computer, a tablet computer, a handheld computer, a smart phone, or a similar device. In some implementations, administrative device 220 may communicate with user device 210 to receive and/or provide (e.g., periodically) information associated with a floor plan, a workspace object, a worker object, a workspace attribute, a worker attribute, a user, or other information discussed herein. In some implementations, administrative device 220 may receive information (e.g., a floor plan) from a first user device 210, and may provide the received information to a second user device 210. Additionally, or alternatively, administrative device 220 may generate a report based on information received from one or more user devices 210, and may provide the report to user device 210.

Network 230 may include one or more wired and/or wireless networks. For example, network 230 may include a cellular network, a public land mobile network (PLMN), a radio access network, a local area network (LAN), a wide area network (WAN), a metropolitan area network (MAN), a telephone network (e.g., the Public Switched Telephone Network (PSTN)), an ad hoc network, an intranet, the Internet, a fiber optic-based network, and/or a combination of these or other types of networks.

The number of devices/networks shown in FIG. 2 is provided as an example. In practice, environment 200 may include additional devices/networks, fewer devices/networks, different devices/networks, or differently arranged devices/networks. Furthermore, two or more devices shown in FIG. 2 may be implemented within a single device, or a single device shown in FIG. 2 may be implemented as multiple, possibly distributed devices. Additionally, one or more of the devices of environment 200 may perform one or more functions described as being performed by another one or more devices of environment 200.

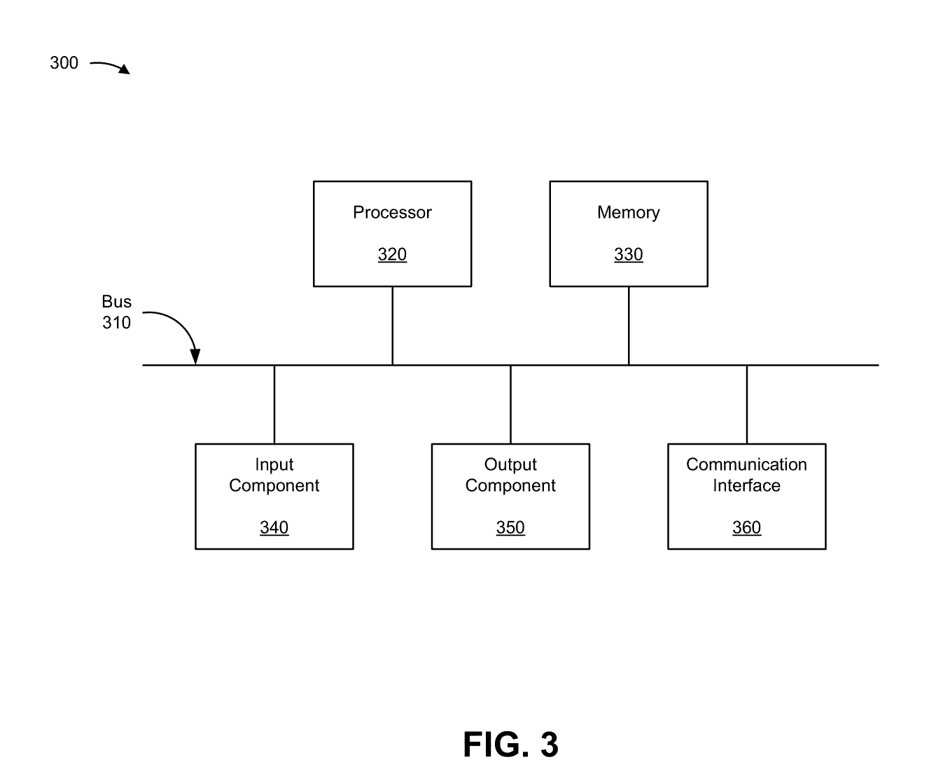

FIG. 3 is a diagram of example components of a device 300, which may correspond to user device 210 and/or administrative device 220. In some implementations, each of user device 210 and/or administrative device 220 may include one or more devices 300 and/or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor (e.g., a central processing unit, a graphics processing unit, an accelerated processing unit), a microprocessor, and/or any processing logic (e.g., a field-programmable gate array (FPGA), an application-specific integrated circuit (ASIC), etc.) that interprets and/or executes instructions. Memory 330 may include a random access memory (RAM), a read only memory (ROM), and/or another type of dynamic or static storage device (e.g., a flash, magnetic, or optical memory) that stores information and/or instructions for use by processor 320.

Input component 340 may include a component that permits a user to input information to device 300 (e.g., a touch screen display, a keyboard, a keypad, a mouse, a button, a switch, etc.). Output component 350 may include a component that outputs information from device 300 (e.g., a display, a speaker, one or more light-emitting diodes (LEDs), etc.).

Communication interface 360 may include a transceiver-like component, such as a transceiver and/or a separate receiver and transmitter, that enables device 300 to communicate with other devices, such as via a wired connection, a wireless connection, or a combination of wired and wireless connections. For example, communication interface 360 may include an Ethernet interface, an optical interface, a coaxial interface, an infrared interface, a radio frequency (RF) interface, a universal serial bus (USB) interface, or the like.

Device 300 may perform various operations described herein. Device 300 may perform these operations in response to processor 320 executing software instructions included in a computer-readable medium, such as memory 330. A computer-readable medium may be defined as a non-transitory memory device. A memory device may include memory space within a single storage device or memory space spread across multiple storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided as an example. In practice, device 300 may include additional components, fewer components, different components, or differently arranged components than those shown in FIG. 3.

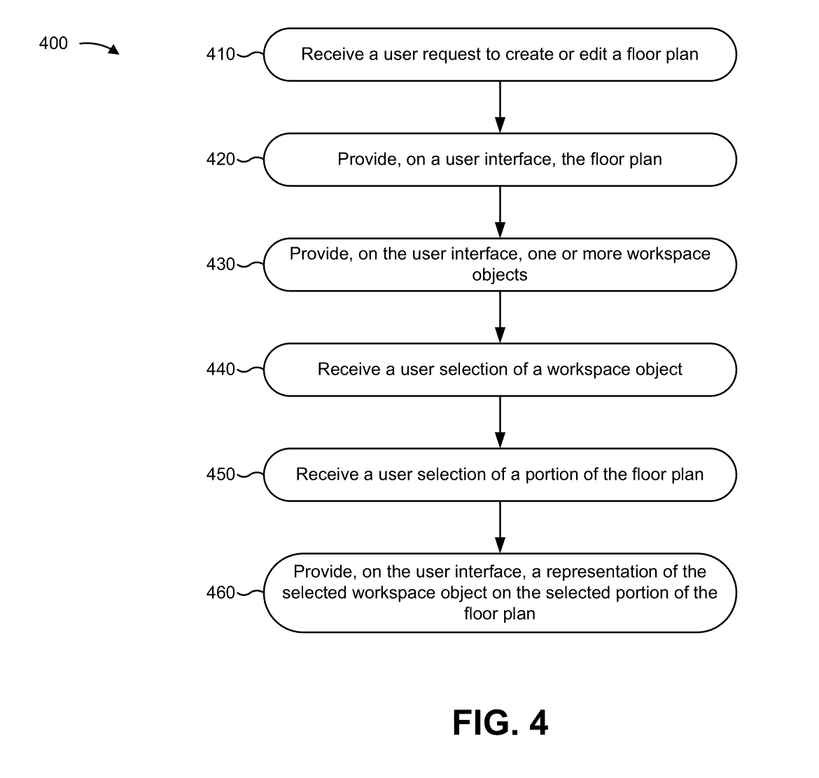

FIG. 4 is a flow chart of an example process 400 for creating or editing a floor plan. In some implementations, one or more process blocks of FIG. 4 may be performed by user device 210. Additionally, or alternatively, one or more process blocks of FIG. 4 may be performed by another device or a group of devices separate from or including user device 210, such as administrative device 220.

As shown in FIG. 4, process 400 may include receiving a user request to create or edit a floor plan (block 410). For example, user device 210 may receive, via a user interface, a user request to create a new floor plan or edit an existing floor plan. In some implementations, user device 210 may receive input that identifies a location associated with the floor plan, such as a campus (e.g., a geographical location of a group of buildings, a campus name, a site name, etc.), a building (e.g., a street address, a building name, etc.), and/or a floor (e.g., a floor number, a floor name, etc.) associated with the floor plan. For example, user device 210 may identify an existing floor plan, for a user to edit, based on a location (e.g., a campus, building, floor, etc.) associated with the existing floor plan. Additionally, or alternatively, user device 210 may associate a new floor plan with a location so that the new floor plan can easily be identified by a user for later editing. In some implementations, administrative device 220 may store one or more location associations, such as a campus and associated buildings, a building and associated floors, etc., and may provide the location associations to user device 210.

As further shown in FIG. 4, process 400 may include providing, on a user interface, the floor plan (block 420). For example, user device 210 may provide the floor plan on a floor plan panel displayed on a portion of the user interface. User device 210 may provide the floor plan based on the received user request. For example, when the user requests a new floor plan, user device 210 may provide a blank floor plan (e.g., an empty grid). When the user requests an existing floor plan, user device 210 may provide the existing floor plan with workspace objects laid out on the existing floor plan (e.g., a floor plan loaded from memory and/or received from administrative device 220).

As still further shown in FIG. 4, process 400 may include providing, on the user interface, one or more workspace objects (block 430). For example, user device 210 may provide the workspace objects on a workspace objects panel displayed on a portion of the user interface. A workspace object may represent one or more employee workspaces, such as a room, an office, a cubicle (sometimes referred to herein as a cube), a work station, a desk, etc. In some implementations, user device 210 may provide the workspace objects based on the received user request. For example, a particular floor of a building may only include offices as workspaces. When the user requests a floor plan associated with the particular floor, user device 210 may provide workspace objects that represent offices (e.g., may not provide cubicles or other workspaces).

As shown in FIG. 4, process 400 may include receiving a user selection of a workspace object (block 440). For example, user device 210 may receive a user selection of a workspace object provided on the user interface. In some implementations, user device 210 may provide, on a workspace attributes panel of the user interface, workspace attributes associated with the selected workspace object.

A workspace attribute may identify, for example, a workspace type (e.g., cubicle, office, etc.), a workspace identifier (e.g., an office number), a size associated with a workspace (e.g., dimensions of the workspace, such as length, width, height, area, etc.), a location of a workspace (e.g., a campus, a building, a floor, etc.), a feature associated with a workspace (e.g., an inside office, a window office, an office number, etc.), a mailbox associated with a workspace (e.g., a mailbox number, a mail drop, etc.), equipment associated with a workspace (e.g., a computer, a telephone, a computer communications port, a telephone communication port, etc.), furniture associated with a workspace (e.g., a desk, a bookshelf, etc. located in the workspace), a capacity associated with a workspace (e.g., a quantity of employees that may utilize the workspace), an availability and/or occupancy associated with a workspace (e.g., an indication of whether the workspace is occupied or available), a worker type associated with a workspace (e.g., an employee, a contractor, a manager, etc. assigned to a workspace), a floor plan associated with a workspace, and/or other information associated with a workspace (e.g., an indication of whether an obstruction, such as a beam or column, is located in the workspace; an indication of whether the workspace is handicap-accessible; a description of the workspace; etc.).

In some implementations, a workspace attribute of a workspace object may be based on another workspace attribute associated with the workspace object, such as a location. For example, the size of an office located on the tenth floor of a building may be larger than the size of an office located on the second floor of the building. In some implementations, a user may edit a workspace attribute associated with a workspace object. For example, a user may provide input, via the workspace attributes panel of the user interface, to edit a workspace attribute. In some implementations, user device 210 may receive information that identifies workspace objects and/or workspace attributes from administrative device 220.

As shown in FIG. 4, process 400 may include receiving a user selection of a portion of the floor plan (block 450), and providing, on the user interface, a representation of the selected workspace object on the selected portion of the floor plan (block 460). For example, user device 210 may receive a user selection of a portion of the floor plan panel of the user interface, and may provide a representation of the selected workspace object on the selected portion of the floor plan panel. In some implementations, a user may add a workspace object representation to the floor plan panel by dragging and dropping a workspace object from the workspace objects panel to the floor plan panel. Additionally, or alternatively, the user may move a workspace object representation to a different location on the floor plan panel, may remove a workspace object representation from the floor plan panel, may edit the workspace object representation on the floor plan panel (e.g., may edit a size, a dimension, a workspace attribute, etc.), etc.

The user may use an input mechanism to interact with and/or perform actions on the user interface, such as keyboard input (e.g., using an arrow key, a delete key, etc.), mouse input (e.g., drag and drop, click, double-click, left click, right click, etc.), interaction with a touch screen (e.g., tap, swipe, etc.), selection of an input mechanism (e.g., a button, a menu item, a link, etc.), etc.

While a series of blocks has been described with regard to FIG. 4, the blocks and/or the order of the blocks may be modified in some implementations. Additionally, or alternatively, non-dependent blocks may be performed in parallel.

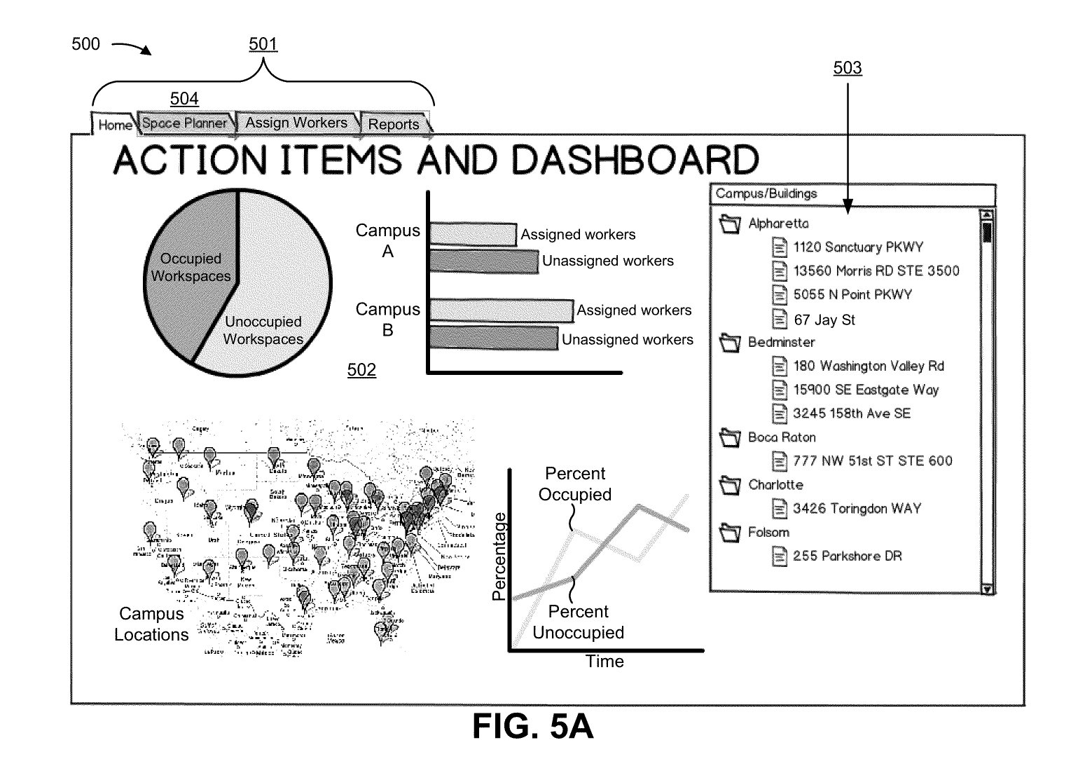

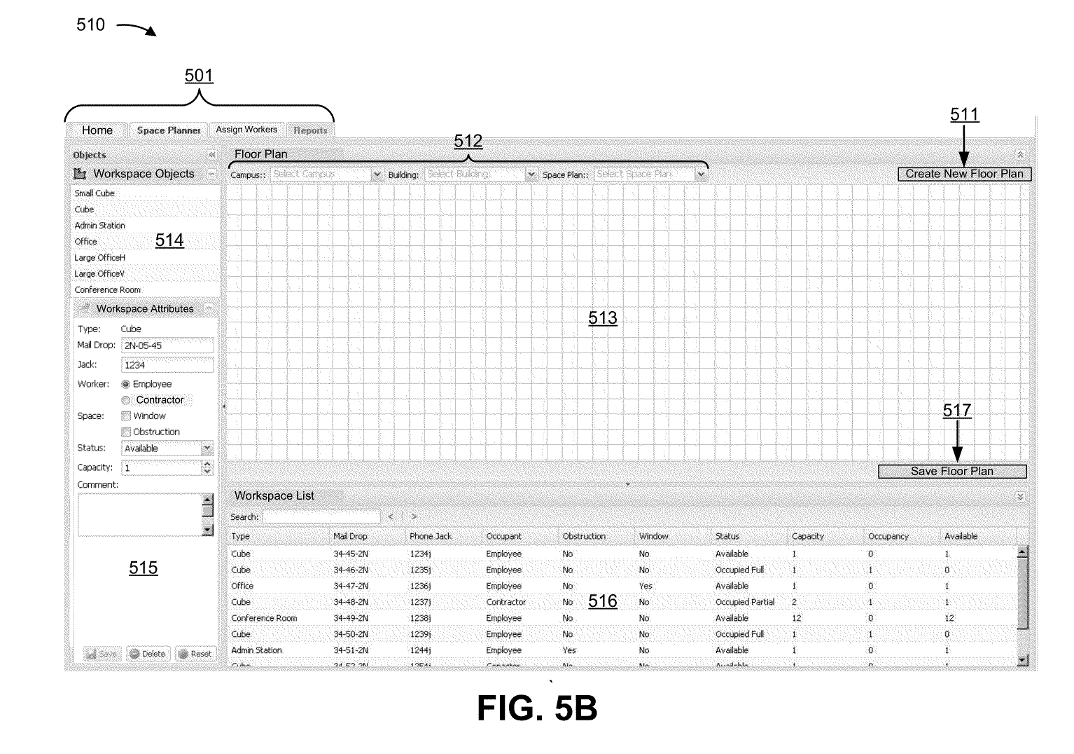

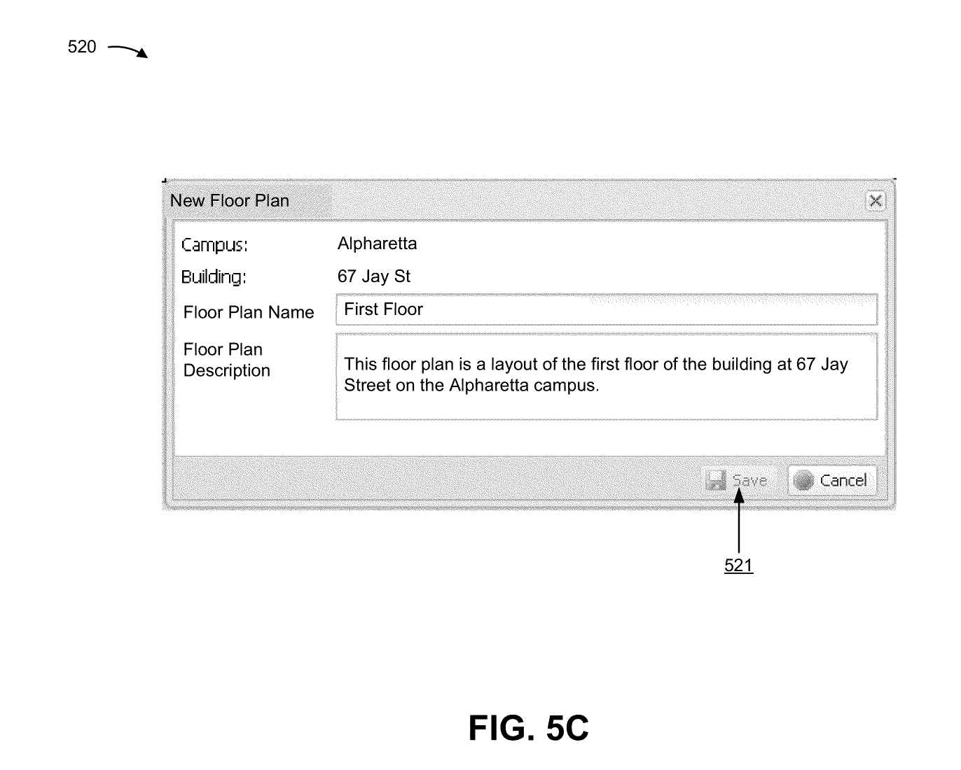

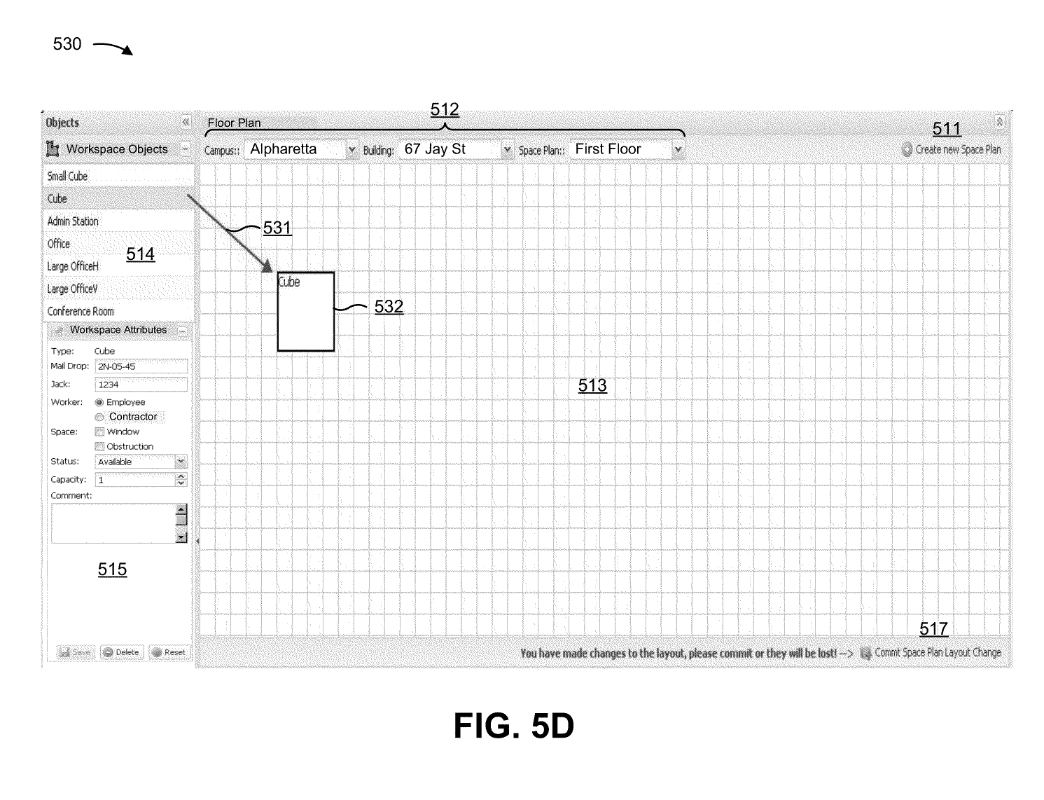

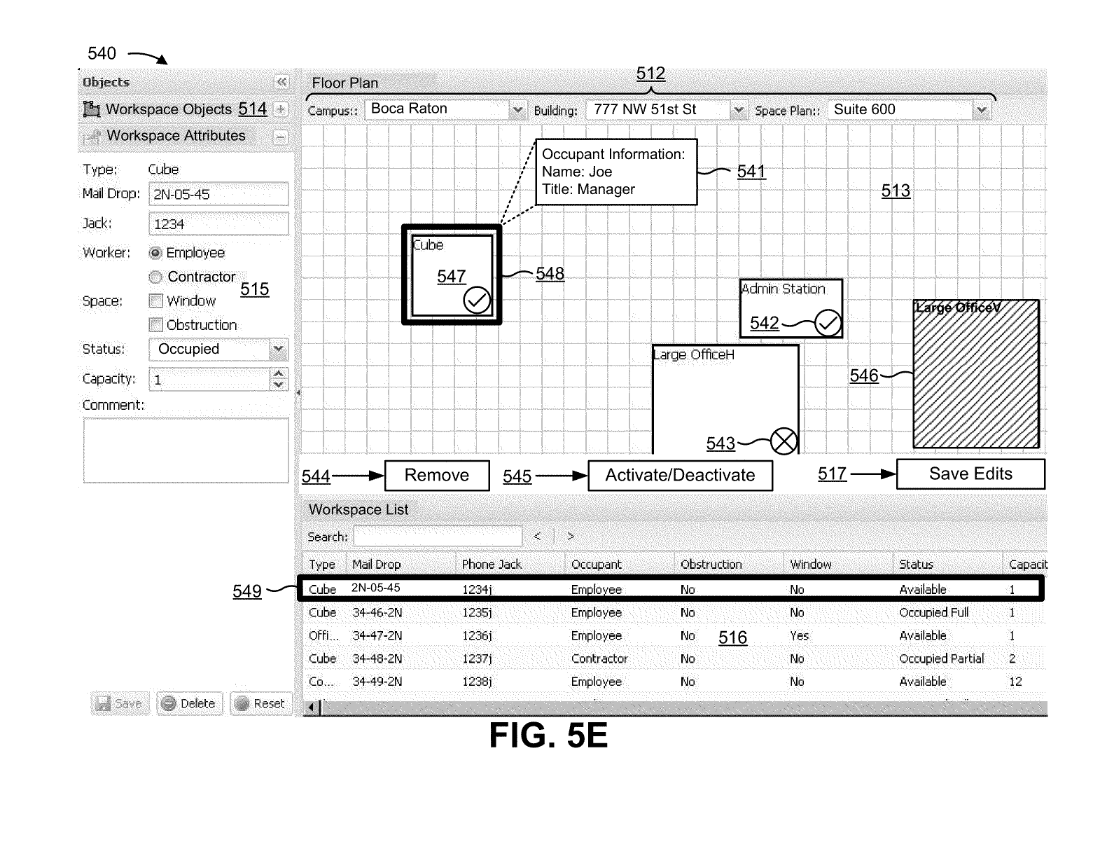

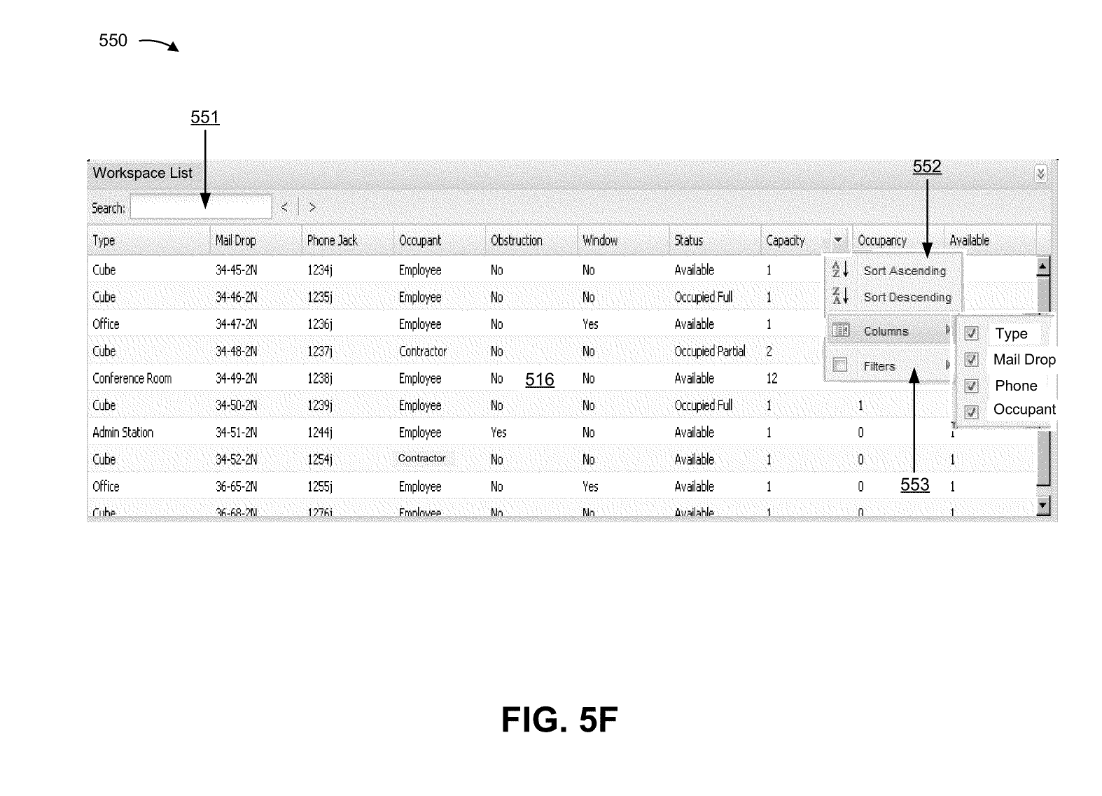

FIGS. 5A-5F are diagrams of example user interfaces 500-550 for implementing example process 400 shown in FIG. 4. In some implementations, user interfaces 500-550 may be provided by user device 210 and/or administrative device 220.

FIG. 5A shows an example user interface 500 of a home screen that may be displayed to a user upon launching a software application that provides functionality described herein. As shown in FIG. 5A, user device 210 may provide user interface 500 when a user navigates to a home tab. The home tab may be provided, for example, in a tab section 501 of the user interface. User interface 500 may include a summary section 502 and a summary selection panel 503.

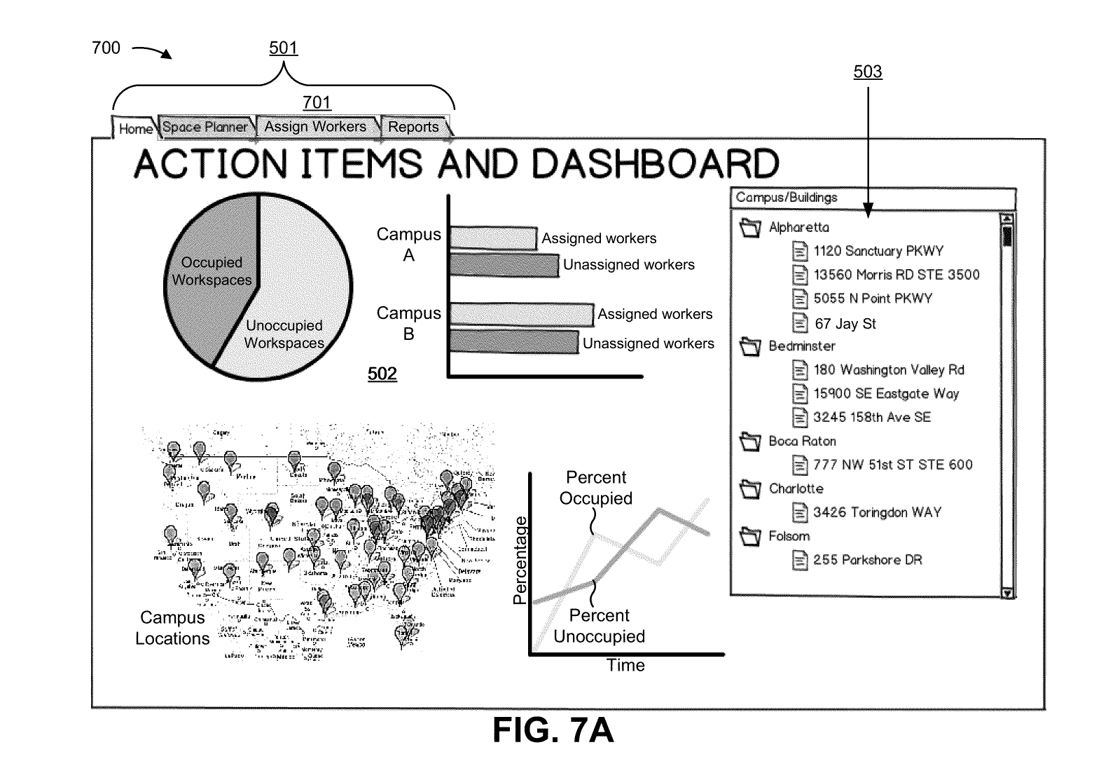

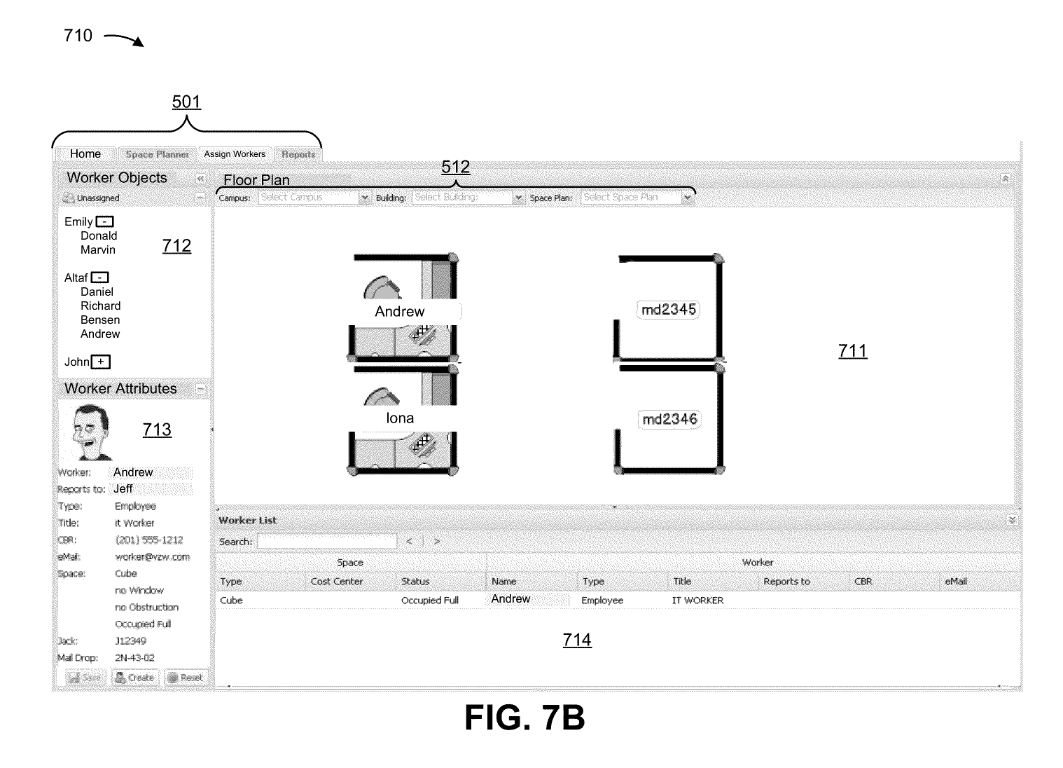

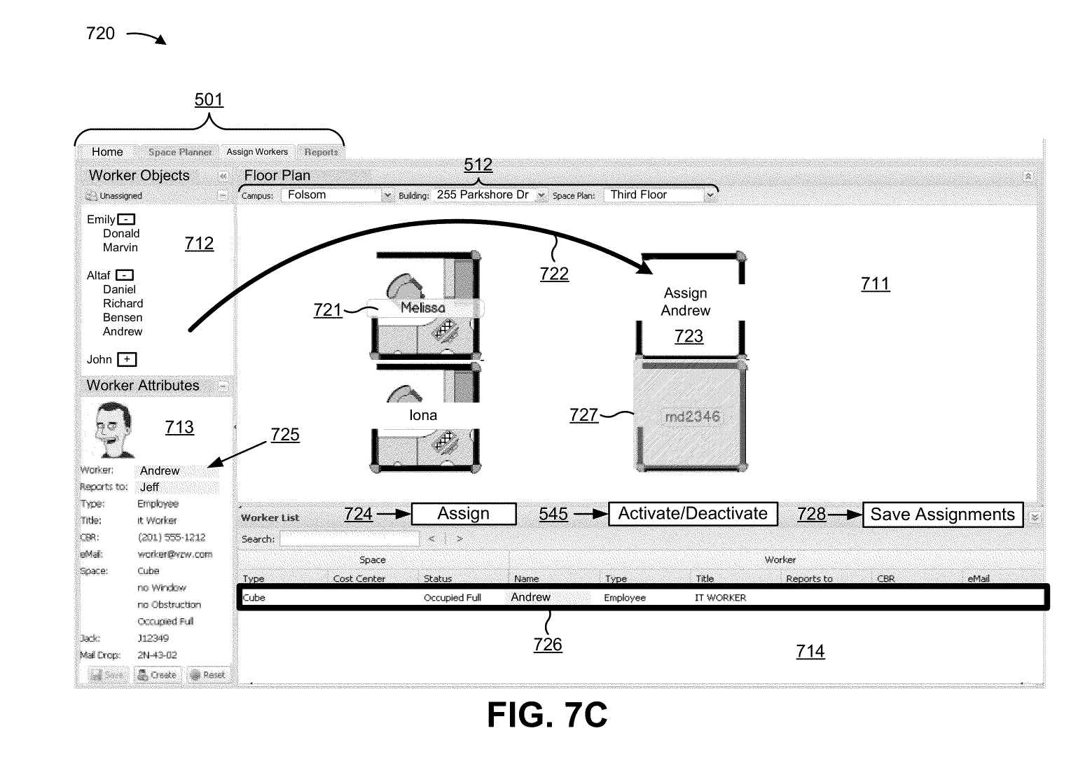

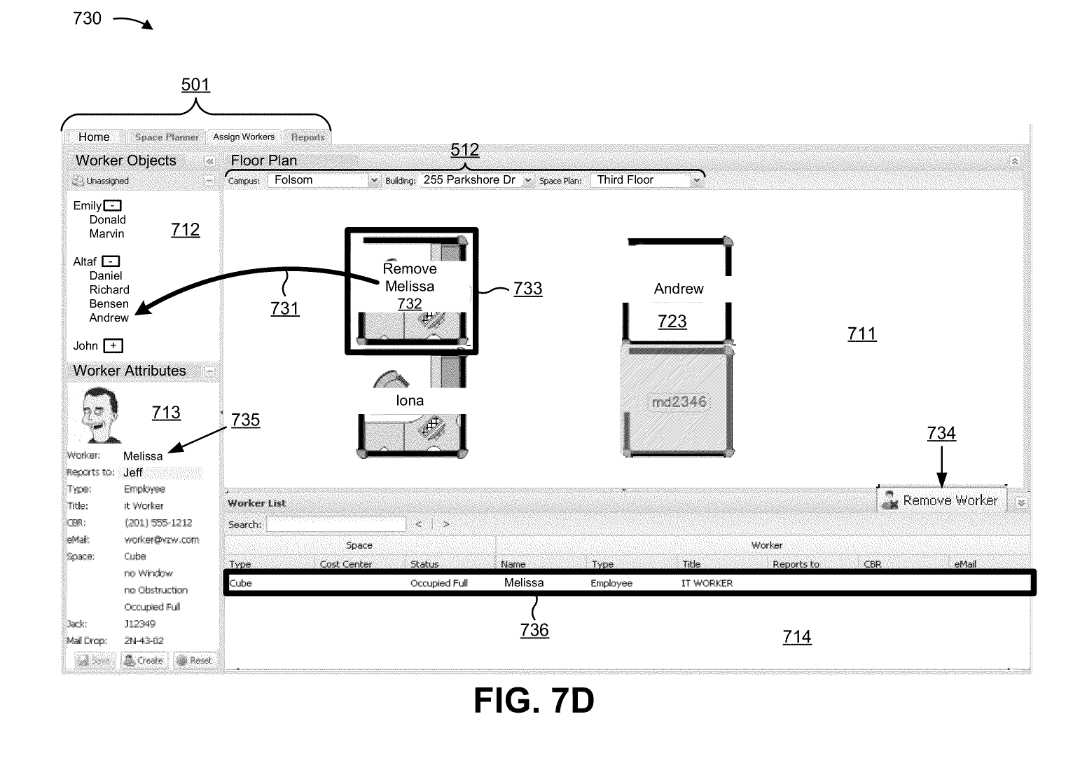

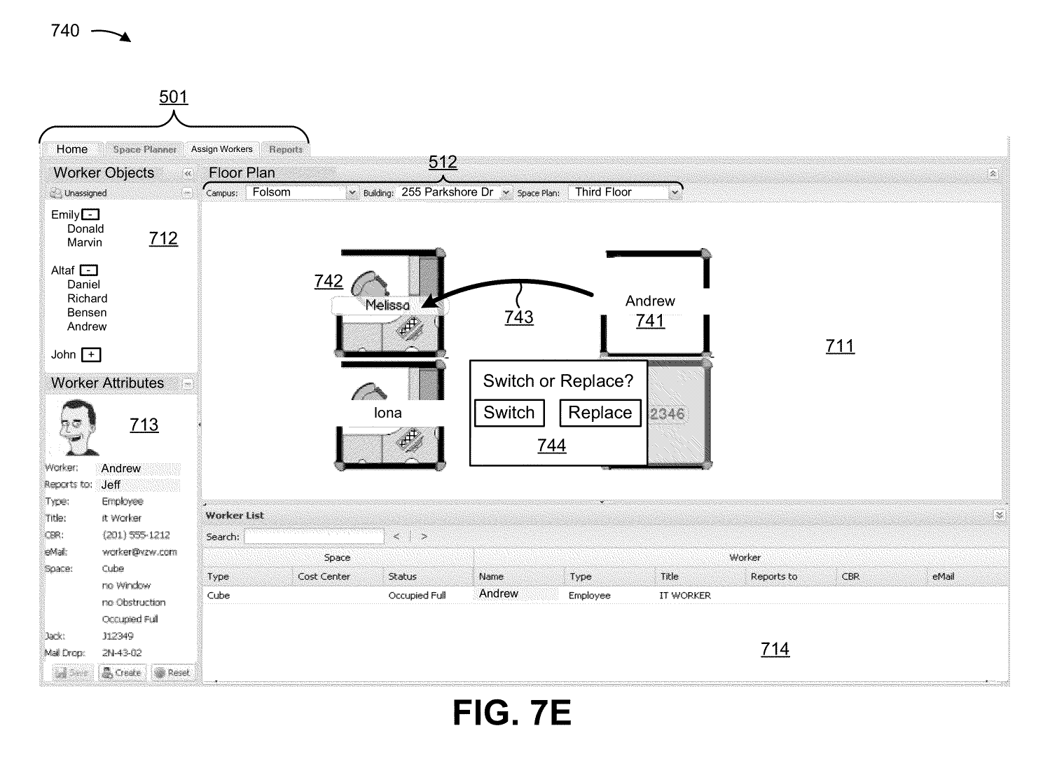

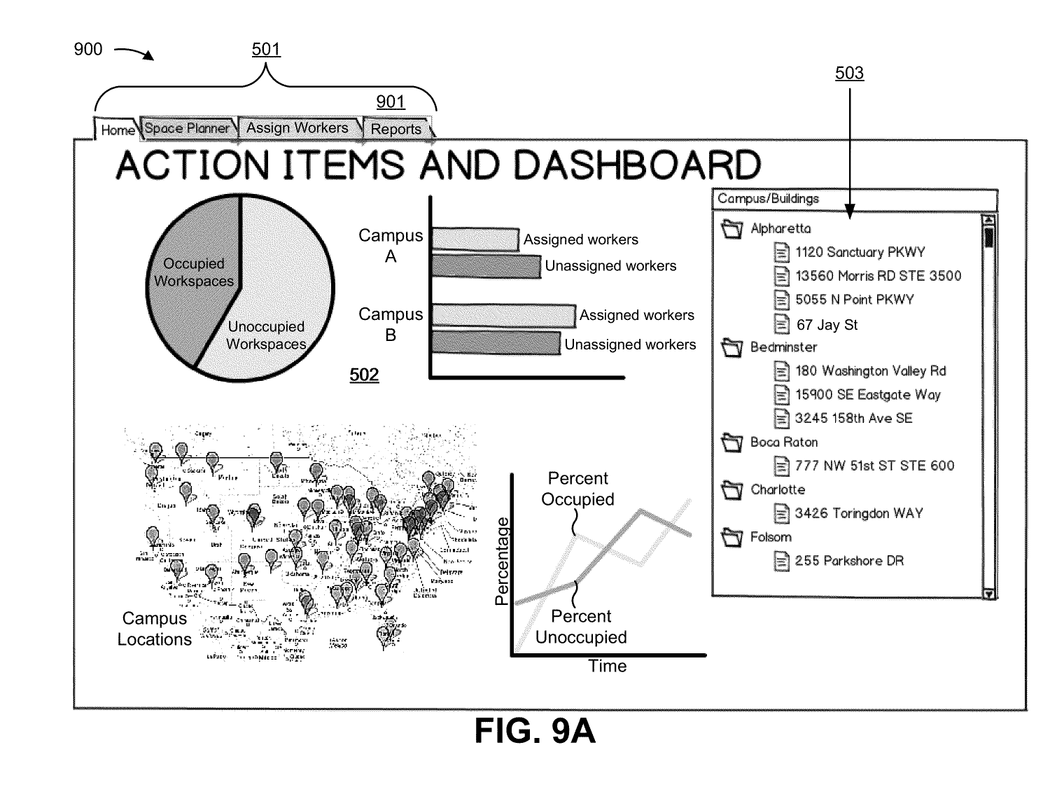

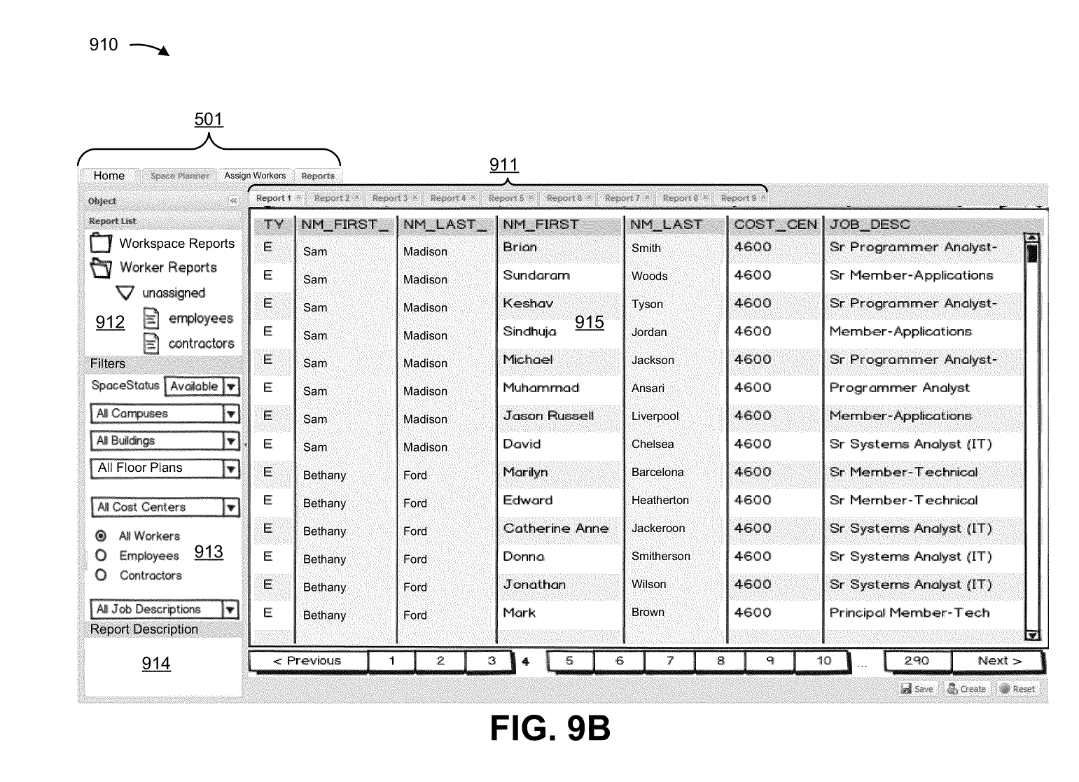

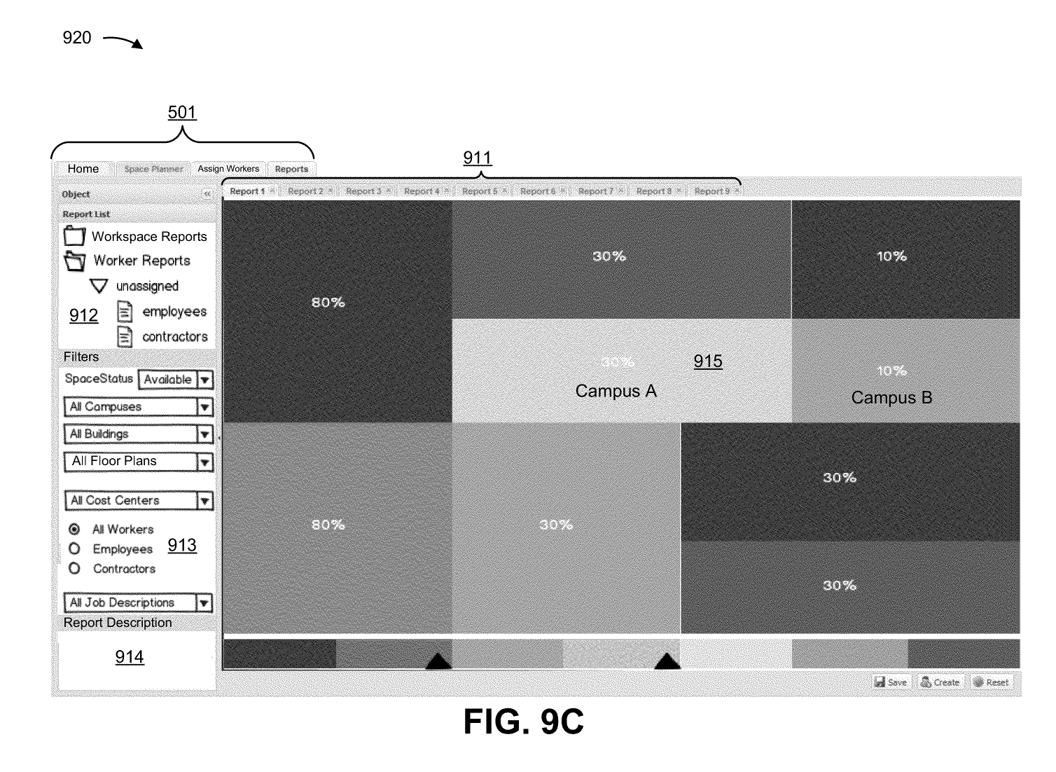

Tab section 501 may provide a mechanism (e.g., a tab, a menu item, etc.) for a user to navigate between user interfaces described herein. For example, the user may interact with a space planner tab to access one or more of user interfaces 510-550 (FIGS. 5B-5F), the user may interact with an assign workers tab to access one or more of user interfaces 710-740 (FIGS. 7B-7E), and the user may interact with a reports tab to access one or more of user interfaces 920-930 (FIGS. 9B-9C).

Summary section 502 may provide one or more dashboards, reports, charts, graphs, maps, actions items, etc. For example, summary section 502 may provide a map of locations associated with an enterprise (e.g., campus and/or building locations), an action item associated with an action to be taken by a user (e.g., creating a floor plan, assigning workers to a floor plan, etc.), a report associated with a floor plan (e.g., described in connection with FIGS. 9A-9C), an alert associated with a floor plan (e.g., a utilization rate of a floor plan satisfying a threshold, a quantity of unassigned workers satisfying a threshold, a quantity of occupied or unavailable workspaces satisfying a threshold, etc.), or other information associated with a floor plan, an enterprise location (e.g., a campus, a building, a floor, etc.), an enterprise workspace (e.g., a utilization rate of offices, cubicles, etc.), and/or an enterprise worker.

In some implementations, summary section 502 may display an alert received from administrative device 220. For example, administrative device 220 may receive an indication that a worker attribute associated with a worker has changed (e.g., the worker is hired, promoted, fired, moved to a different location or department, etc.). Administrative device 220 may provide the indication to user device 210, and user device 210 may display the indication on summary section 502 so that a user may take appropriate action (e.g., change a workspace to which the worker is assigned, assign a hired worker to a workspace, etc.).

Summary selection panel 503 may provide a representation (e.g., a list) of one or more items to be summarized in summary section 502. For example, a user may select a summary item from summary selection panel 503, and information associated with the selected summary item may be provided on summary section 502. A summary item may include, for example, a report (e.g., a type of report), an enterprise location (e.g., a campus, building, floor, etc.), an enterprise workspace (e.g., a workspace type, such as an office, a cubicle, etc.), an enterprise worker (e.g., a worker type, such as a line worker, a staff worker, a manager, a salesperson, etc.), etc.

In some implementations, a user may navigate to a space planner tab 504 in tab section 501, which may cause user device 210 to provide user interface 510 of FIG. 5B.

FIG. 5B shows an example user interface 510 that provides a mechanism for a user to create, edit, and/or interact with a floor plan. In some implementations, user interface 510 may be displayed when the user selects space planner tab 504 (FIG. 5A). As shown in FIG. 5B, user interface 510 may include tab section 501 (described herein in connection with FIG. 5A), a new floor plan button 511, a floor plan selection mechanism 512, a floor plan panel 513, a workspace objects panel 514, a workspace attributes panel 515, a workspace list panel 516, and a save floor plan button 517.

New floor plan button 511 may provide an input mechanism (e.g., a button, a tab, a link, a menu item, etc.) for a user to create a new floor plan. In some implementations, the user may input a campus, a building, and/or a floor associated with the new floor plan, as described herein in connection with FIG. 5C.

Floor plan selection mechanism 512 may provide an input mechanism (e.g., a drop down box, a check box, a menu item, etc.) for a user to select a location (e.g., a campus, a building, a floor, etc.) associated with a floor plan. In some implementations, the user may select a location, and may create a new floor plan associated with the selected location. Additionally, or alternatively, the user may select an existing floor plan (e.g., by selecting a location), and the existing floor plan may be provided on floor plan panel 513.

In some implementations, user device 210 may receive, from administrative device 220, one or more locations available for selection by the user. Additionally, or alternatively, user device 210 may receive information that identifies relationships between locations. For example, a building available for selection may depend on a selected campus, a floor available for selection may depend on a selected campus and/or building, etc.

Floor plan panel 513 may display a floor plan. When the user requests to create a new floor plan, floor plan panel 513 may provide a blank floor plan (e.g., an empty grid), as shown. The user may add workspace objects to the floor plan, as described herein in connection with FIG. 5D. Alternatively, when the user requests an existing floor plan, floor plan panel 513 may provide the existing floor plan with workspace objects laid out on the existing floor plan, as described herein in connection with FIG. 5E.

Workspace objects panel 514 may display one or more workspace objects. A workspace object may represent a workspace, such as a small cubicle, a cubicle, an administration station, an office, a large horizontal office, a large vertical office, or a conference room, as shown. In some implementations, user device 210 may receive, from administrative device 220, information identifying workspace objects associated with a selected location, and may display the identified workspace objects in workspace objects panel 514.

Additionally, or alternatively, user device 210 may provide workspace objects in workspace objects panel 514 based on the user interacting with user interface 510. For example, a user may be required to enter a login credential to create or edit a floor plan. Based on the login credential, user device 210 may receive information associated with the user (e.g., from administrative device 220), and may provide workspace objects in workspace objects panel 514 based on the user. For example, user device 210 may provide workspace objects associated with workspaces that the user is responsible for managing.

In some implementations, the user may add workspace objects to a floor plan by, for example, dragging and dropping a workspace object from workspace objects panel 514 to floor plan panel 513. In some implementations, user selection of a workspace object on workspace objects panel 514 and/or floor plan panel 513 may cause workspace attributes panel 515 to display attributes associated with the selected workspace object.

Workspace attributes panel 515 may display one or more workspace attributes associated with a workspace (e.g., a selected workspace). In some implementations, user device 210 may receive, from administrative device 220, information identifying workspace attributes associated with a workspace, and may display the identified workspace attributes in workspace attributes panel 515. Additionally, or alternatively, the user may edit workspace attributes associated with a workspace by editing information displayed in workspace attributes panel 515.

Workspace list panel 516 may display one or more workspace attributes associated with one or more workspaces, and may provide an input mechanism (e.g., a button, a drop down list, a text box, a search box, etc.) for a user to search, sort, and/or filter the displayed workspaces and/or workspace attributes. The workspaces displayed in workspace list panel 516 may be associated with a selected location (e.g., a floor plan displayed on floor plan panel 513).

Save floor plan button 517 may provide an input mechanism (e.g., a button, a tab, a link, a menu item, etc.) for a user to save a floor plan. For example, user selection of save floor plan button 517 may cause user device 210 to save the floor plan provided in floor plan panel 513 (e.g., to a data structure associated with and/or accessible by user device 210 and/or administrative device 220). The saved floor plan may be associated with a location so that the saved floor plan may be easily retrieved by a user.

FIG. 5C shows an example user interface 520 that provides a mechanism for a user to create a new floor plan. In some implementations, user interface 520 may be displayed when the user selects new floor plan button 511 (FIG. 5B).

As shown in FIG. 5C, a user may input information that identifies a campus, a building, a floor plan name, and a floor plan description associated with a new floor plan. In some implementations, the campus and/or building may be determined based on a campus and/or building selected via floor plan selection mechanism 512 prior to user selection of new floor plan button 511. Additionally, or alternatively, the campus and/or building may be input by a user via user interface 520 (e.g., via a drop down box, a text box, etc.). For example, the user may input a campus of “Alpharetta,” a building of “67 Jay St,” a floor plan name of “First Floor,” and a floor plan description of “This floor plan is a layout of the first floor of the building at 67 Jay Street on the Alpharetta campus.”

The user may select a save button 521, which may save the information input via user interface 520, and may cause user device 210 to return to user interface 510 so that the user may create a layout for the new floor plan.

FIG. 5D shows an example user interface 530 that may correspond to user interface 510 (FIG. 5B), and may include new floor plan button 511, floor plan selection mechanism 512, floor plan panel 513, workspace objects panel 514, workspace attributes panel 515, save floor plan button 517, and/or other elements described herein in connection with FIG. 5B (e.g., workspace list panel 516, not shown in FIG. 5D). In some implementations, user interface 530 may be displayed when the user selects save button 521 (FIG. 5C).

As shown in FIG. 5D, a user may create a new floor plan associated with a location. For example, as shown by floor plan selection mechanism 512, the user may create a new floor plan associated with the first floor of the building at 67 Jay Street on the Alpharetta campus.

As shown by reference number 531, a user may click, drag, and drop a workspace object from workspace objects panel 514 to a portion of floor plan panel 513. As shown by reference number 532, user interface 530 may provide a representation of the workspace object on the portion of floor plan panel 513. For example, the user may drag and drop a cubicle (cube) object from workspace objects panel 514 to a portion of floor plan panel 513, as shown. User interface 530 may display, on the portion of floor plan panel 513, a rectangle that represents the cubicle. In some implementations, workspace list panel 516 (not shown) may display information (e.g., workspace attributes) associated with one or more workspace objects that are added to the floor plan and/or displayed on floor plan panel 513.

The user may add multiple workspace objects to floor plan panel 513 to create a floor plan that corresponds to the first floor of the building at 67 Jay Street on the Alpharetta campus. A workspace object may be associated with a size, a shape, a dimension, etc., which may be a scaled representation of an actual workspace at 67 Jay Street. User device 210 may receive information that identifies the size, shape, dimension, etc. (e.g., of the actual workspace) from administrative device 220.

In some implementations, a user may remove a workspace object from the floor plan, such as by dragging and dropping a workspace object from floor plan panel 513 to workspace objects panel 514, by selecting a workspace object on floor plan panel 513 and inputting a delete command (e.g., via a delete key or button), etc. Additionally, or alternatively, a user may move a workspace object to a different area on the floor plan, such as by dragging and dropping a workspace object from a first portion of floor plan panel 513 to a second portion of floor plan panel 513, by selecting a workspace object on floor plan panel 513 an inputting a move command (e.g., via an arrow key or button), etc.

Once a user has finished laying out the floor plan, the user may select save floor plan button 517 to save the floor plan. Additionally, or alternatively, the user may interact with floor plan selection mechanism 512 to select an existing floor plan to edit, as described in connection with FIG. 5E.

FIG. 5E shows an example user interface 540 that may correspond to user interface 510 (FIG. 5B), and may include floor plan selection mechanism 512, floor plan panel 513, workspace objects panel 514, workspace attributes panel 515, workspace list panel 516, save floor plan button 517, and/or other elements described herein in connection with FIG. 5B (e.g., tab section 501 and/or new floor plan button 511, not shown in FIG. 5E). In some implementations, user interface 540 may be displayed based on user interaction with floor plan selection mechanism 512.

As shown in FIG. 5E, a user may interact with floor plan selection mechanism 512 to select an existing floor plan associated with suite 600 of the building at 777 NW 51st Street on the Boca Raton campus. Based on the user selection, user interface 540 may provide the existing floor plan (e.g., previously created and/or saved) in floor plan panel 513, as shown. In some implementations, user device 210 may receive the existing floor plan from administrative device 220.

User interface 540 may display, in floor plan panel 513, one or more workspaces associated with the selected floor plan. Additionally, or alternatively, user interface 540 may provide information associated with the workspaces. As shown by reference number 541, user interface 540 may provide a worker attribute of a worker associated with a workspace. For example, the worker attribute may identify a worker name (e.g., Joe), a worker title (e.g., manager), and/or another worker attribute associated with a worker identified as occupying a particular workspace.

In some implementations, user interface 540 may provide an indication of whether a workspace is occupied (e.g., whether a worker has been assigned to the workspace). As shown by reference number 542, user interface 540 may display a check mark (or another indicator) on a workspace object representation associated with an occupied workspace. As shown by reference number 543, user interface 540 may display an X (or another indicator) on a workspace object representation associated with an unoccupied workspace.

As shown by reference number 544, user interface 540 may provide a mechanism (e.g., a button, a menu item, etc.) for a user to remove a workspace from the floor plan. For example, a user may remove a workspace from the floor plan be selecting a workplace displayed on floor plan panel 513 and interacting with remove workspace button 544.

As shown by reference number 545, user interface 540 may provide a mechanism (e.g., a button, a menu item, etc.) for a user to activate or deactivate a workspace. A workspace that is activated may be assigned to a worker, and a workspace that is deactivated may not be assigned to a worker (e.g., has a capacity of zero). User interface 540 may provide an indication of whether a workspace is activated or deactivated. For example, as shown by reference number 546, a deactivated workspace may be displayed with lines through it and/or may be grayed out.

In some implementations, if a user attempts to remove an occupied workspace from the floor plan and/or attempts to deactivate an occupied workspace, user interface 540 may display a message informing the user that the workspace is occupied, and asking the user whether the user still wants to remove or deactivate the occupied workspace. If the user responds yes, user device 210 may remove the occupied workspace from the floor plan, or may deactivate the workspace, and may add the occupant (e.g., a worker) to a list of unassigned workers (discussed in more detail in connection with FIGS. 7B and 7C).

As further shown in FIG. 5E, the user may select a workspace object provided on floor plan panel 513, such as cubicle 547. Based on the user selection, user device 210 may highlight cubicle 547 (e.g., by outlining cubicle 547, changing a color of cubicle 547, etc.), as shown by reference number 548. Additionally, or alternatively, user device 210 may provide workspace attributes associated with the selected workspace object in workspace attributes panel 515 (and/or in a pop-up window, as indicated by reference number 541). For example, workspace attributes panel 515 may identify a workspace type associated with cubicle 547 (e.g., cubicle or cube), a mail drop associated with cubicle 547 (e.g., 2N-05-45), a phone jack associated with cubicle 547 (e.g., 1234), a worker type assigned to and/or occupying cubicle 547 (e.g., employee), a feature associated with cubicle 547 (e.g., not a window office, does not include an obstruction), an availability status of cubicle 547 (e.g., occupied), a capacity of cubicle 547 (e.g., one), and/or other workspace attributes associated with cubicle 547.

Additionally, or alternatively, based on user selection of cubicle 547, user device 210 may highlight information associated with cubicle 547 in workspace list panel 516, and may provide workspace attributes associated with cubicle 547 in workspace list panel 516, as shown by reference number 549. Similarly, user selection of cubicle 547 in workspace list panel 516 may cause user device 210 to highlight cubicle 547 in floor plan panel 513, and/or may cause user device 210 to provide workspace attributes associated with cubicle 547 in workspace attributes panel 515.

FIG. 5F shows an example user interface 550 that may correspond to workspace list panel 516. As shown in FIG. 5F, workspace list panel 516 may include a search mechanism 551, a sort mechanism 552, and a filter mechanism 553.

As further shown in FIG. 5F, workspace list panel 516 may display one or more workspace attributes associated with one or more workspaces. For example, workspace list panel 516 may display information that identifies a workspace type associated with a workspace (e.g., a cubicle, an office, etc.), a mail drop associated with a workspace (e.g., mail drop 34-45-2N), a phone jack associated with a workspace (e.g., phone jack 1234j), an occupant associated with a workspace (e.g., a worker type, such as employee, contractor, etc.; an occupant name; an occupant job title; etc.), an indication of whether there is an obstruction associated with a workspace (e.g., a column located in a room), an indication of whether a workspace includes a window, an occupancy or availability status associated with a workspace (e.g., available, partially occupied, fully occupied, etc.), a capacity associated with a workspace (e.g., a quantity of workers that the workspace can support), a quantity of workers occupying and/or assigned to the workspace, a quantity of available and/or unassigned work stations associated with a workspace, etc.

In some implementations, the workspaces displayed in workspace list panel 516 may be associated with a selected location and/or floor plan (e.g., selected via floor plan selection mechanism 512). Additionally, or alternatively, the workspaces displayed in workspace list panel 516 may be based on user input provided via search mechanism 551, sort mechanism 552, and/or filter mechanism 553.

Search mechanism 551 may provide a mechanism (e.g., a text box, a check box, etc.) for a user to search for a workspace. For example, a user may input a search string that specifies one or more workspaces and/or workspace attributes, and workspace list panel 516 may display the specified workspaces and/or workspaces that satisfy the specified workspace attributes.

Sort mechanism 552 may provide a mechanism (e.g., a drop down box, a menu item, etc.) for a user to sort one or more columns displayed by workspace list panel 516. For example, a user may provide input to sort a column in ascending order (e.g., from A to Z, in order of increasing quantity, etc.) or descending order (e.g., from Z to A, in order of decreasing quantity, etc.).

Filter mechanism 553 may provide a mechanism (e.g., a menu item, a check box, etc.) for a user to filter the information displayed by workspace list panel 516. For example, a user may select one or more columns to display or not display, and workspace list panel 516 may display or not display columns accordingly. As another example, a user may select one or more filter criteria (e.g., display or remove partially occupied workspaces; fully occupied workspaces; available workspaces; workspaces with a capacity, availability, or occupancy that satisfies a threshold; workspaces with or without a window; workspaces with or without an obstruction; workspaces of a particular type; workspaces associated with a particular workspace attribute and/or worker attribute; workspaces with a phone jack; etc.), and workspace list panel 516 may display information associated with one or more workspaces based on the filter criteria.

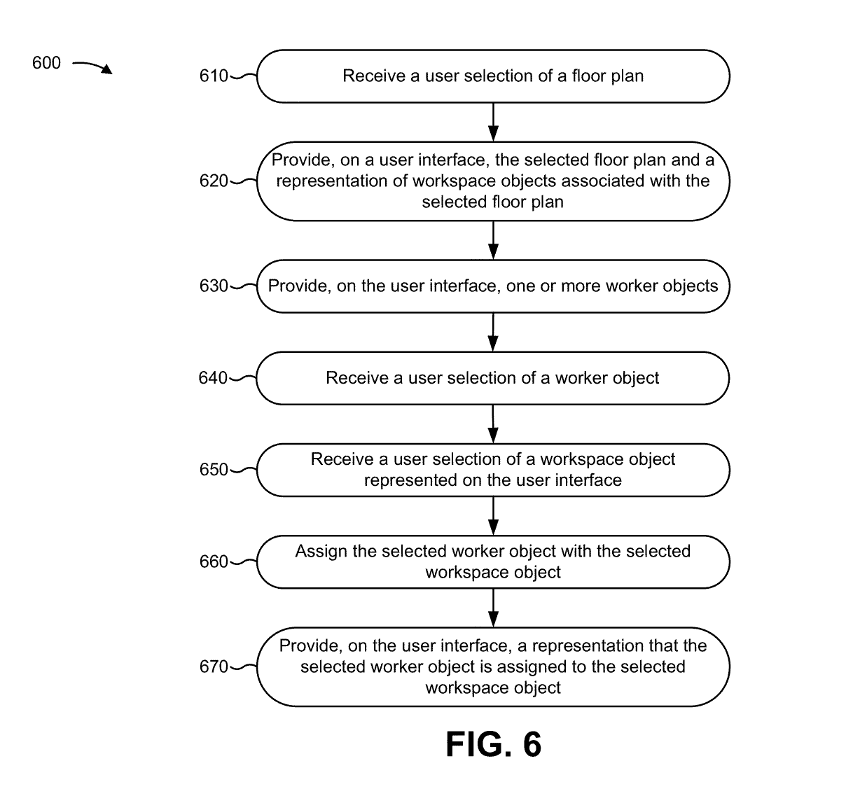

FIG. 6 is a flow chart of an example process 600 for associating workers with the floor plan. In some implementations, one or more process blocks of FIG. 6 may be performed by user device 210. Additionally, or alternatively, one or more process blocks of FIG. 6 may be performed by another device or a group of devices separate from or including user device 210, such as administrative device 220.

As shown in FIG. 6, process 600 may include receiving a user selection of a floor plan (block 610), and providing, on a user interface, the selected floor plan and a representation of workspace objects associated with the selected floor plan (block 620). For example, user device 210 may receive, via a user interface, a user selection of a floor plan (e.g., an existing floor plan). Based on the user selection, user device 210 may provide the selected floor plan, and a representation of workspace objects associated with the selected floor plan, on a floor plan panel displayed on a portion of the user interface. In some implementations, user device 210 may receive information that identifies the selected floor plan and/or the workspace objects from administrative device 220.

As further shown in FIG. 6, process 600 may include providing, on the user interface, one or more worker objects (block 630). For example, user device 210 may provide the worker objects on a worker objects panel displayed on a portion of the user interface. A worker object may represent a worker associated with an enterprise, such as an employee, a contractor, an agent, a laborer, a member, etc., of an enterprise, or any other person that performs work for an enterprise. In some implementations, user device 210 may provide the worker objects based on the selected floor plan (e.g., based on a selected location). For example, a particular location may be associated with a particular group of workers that work at the particular location. When the user selects a floor plan associated with the particular location, user device 210 may provide worker objects that represent the particular group of workers. In some implementations, user device 210 may receive information that identifies the group of workers associated with the location from administrative device 220.

In some implementations, user device 210 may provide information that identifies an assigned worker and/or an unassigned worker. An assigned worker may include a worker that has been assigned to a workspace, and an unassigned worker may include a worker that has not been assigned to a workspace. User device 210 may provide information that identifies an assigned worker in the floor plan panel (e.g., associated with a workspace to which the worker is assigned). User device 210 may provide information that identifies an unassigned worker in the worker objects panel.

As shown in FIG. 6, process 600 may include receiving a user selection of a worker object (block 640). For example, user device 210 may receive a user selection of a worker object provided on the user interface (e.g., in the floor plan panel and/or the worker objects panel). In some implementations, user device 210 may provide, on a worker attributes panel of the user interface, worker attributes associated with the selected worker object.

A worker attribute may identify, for example, a name of a worker (e.g., a legal name, a first name, a last name, a full name, etc.), a worker type (e.g., employee, contractor, etc.), contact information for a worker (e.g., a phone number, an email address, a home address, a work address, etc.), a job title of a worker (e.g., manager, accountant, lawyer, etc.), a job description of a worker, a cost center or department of a worker (e.g., accounting, sales, legal, administration, human resources, operations, manufacturing, etc.), a manager of a worker (e.g., a manager name, a manager title, etc.), workspace attributes (e.g., of a workspace to which a worker is assigned), a location (e.g., a campus, a building, a floor, etc.) associated with a worker, a floor plan associated with a worker, and/or other information associated with a worker (e.g., an indication of whether a worker is handicapped or has special needs).

In some implementations, a worker attribute of a worker object may be based on a floor plan associated with the worker object. For example, a particular floor of a building may include a particular worker type (e.g., maintenance workers may work in the basement). In some implementations, a user may edit a worker attribute associated with a worker object. For example, a user may provide input, via the worker attributes panel of the user interface, to edit a worker attribute. In some implementations, user device 210 may receive information that identifies worker objects and/or worker attributes from administrative device 220.

As shown in FIG. 6, process 600 may include receiving a user selection of a workspace object represented on the user interface (block 650), assigning the selected worker object with the selected workspace object (block 660), and providing, on the user interface, a representation that the selected worker object is assigned to the selected workspace object (block 670). For example, user device 210 may receive a user selection of a workspace object displayed in the floor plan panel, and may assign the selected worker object to the selected workspace object (e.g., by storing an association between the worker object and the workspace object in a data structure). Additionally, or alternatively, user device 210 may provide a representation, on the floor plan panel, that the selected worker object is assigned to the selected workspace object.

In some implementations, a user may assign a worker to a workspace object by dragging and dropping a worker object from the worker objects panel to the workspace object represented on the floor plan panel. Additionally, or alternatively, the user may re-assign a worker to a different workspace object represented on the floor plan panel, may remove a worker assignment from a workspace object represented on the floor plan panel, may edit the worker object and/or a relationship between the worker object and the workspace object (e.g., may assign a worker to a different work station within a workspace), etc.

While a series of blocks has been described with regard to FIG. 6, the blocks and/or the order of the blocks may be modified in some implementations. Additionally, or alternatively, non-dependent blocks may be performed in parallel.

FIGS. 7A-7E are diagrams of example user interfaces 700-740 for implementing example process 600 shown in FIG. 6. In some implementations, user interfaces 700-740 may be provided by user device 210 and/or administrative device 220.

FIG. 7A shows an example user interface 700 that may correspond to user interface 500 (FIG. 5A), and may include tab section 501, summary section 502, and summary selection panel 503. In some implementations, a user may navigate to an assign workers tab 701 in tab section 501, which may cause user device 210 to provide user interface 710 of FIG. 7B.

FIG. 7B shows an example user interface 710 that provides a mechanism for a user to interact with worker objects. In some implementations, user interface 710 may be displayed when the user selects assign workers tab 701 (FIG. 7A). As shown in FIG. 7B, user interface 710 may include tab section 501, floor plan selection mechanism 512, a worker assignment panel 711, a worker objects panel 712, a worker attributes panel 713, and a worker list panel 714.

Worker assignment panel 711 may display a floor plan, and may correspond to floor plan panel 513. For example, the user may select an existing floor plan (e.g., via floor plan selection mechanism 512), and the existing floor plan may be provided on worker assignment panel 711. In some implementations, a user may not edit the floor plan via user interface 710 and/or via worker assignment panel 711, and worker assignment panel 711 may not display a grid. Worker assignment panel 711 may display a workspace object representation, and may display a worker object representation associated with a displayed workspace object representation. The user may assign workers to workspace objects, as described herein in connection with FIG. 7C.

Worker objects panel 712 may display one or more worker objects. A worker object may represent a worker. In some implementations, worker objects panel 712 may display information that identifies unassigned workers (e.g., workers that have not been assigned to a workspace). Additionally, or alternatively, worker objects panel 712 may display workers in a collapsible tree structure that indicates relationships between workers. For example, a line worker (e.g., a manager, supervisor, etc.) may manage one or more staff workers (e.g., a worker that does not manager or supervise another worker) and/or one or more other line workers. For example, Donald and Marvin may be staff workers, who are supervised by Emily, a line worker, as shown.

In some implementations, worker objects panel 712 may display line workers associated with a selected floor plan, and may display unassigned staff workers associated with the selected floor plan. Additionally, or alternatively, worker objects panel 712 may display line workers that supervise unassigned staff workers, and may not display line workers whose staff workers have been assigned. Additionally, or alternatively, worker objects panel 712 may display line workers that supervise an unassigned staff worker associated with a selected floor plan. In some implementations, a line worker may be assigned to multiple workspaces, and a staff worker may be assigned to one workspace. Alternatively, a worker may be assigned to one workspace in multiple locations (e.g., in multiple buildings, at multiple campuses, on multiple floors, etc.).

In some implementations, user device 210 may receive, from administrative device 220, information that identifies a worker object assigned to and/or associated with a location, a floor plan, a worker attribute, a workspace, etc. Worker objects panel 712 may display worker objects associated with workers that are associated with a selected location, floor plan, and/or worker attribute, but may not display worker objects associated with workers that are assigned to a workspace. Worker objects may be added to or removed from worker list panel 712 when a worker moves to a different location (e.g., a different campus, building, floor, etc.). For example, administrative device 220 may receive information identifying that a worker moved from a first building to a second building. Administrative device 220 may provide this information to user device 210 (e.g., may provide an alert to user interface 710). User device 210 may not display a worker object associated with the worker when the user selects the first building, and may display a worker object associated with the worker when the users selects the second building.

Additionally, or alternatively, user device 210 may provide worker objects in worker objects panel 712 based the user interacting with user interface 730. For example, a user may be required to enter a credential to login to assign workers. Based on the credential, user device 210 may receive information associated with the user (e.g., from administrative device 220), and may provide worker objects in worker objects panel 712 based on the user. For example, user device 210 may provide worker objects associated with workers that the user is responsible for managing.

The user may assign workers to a workspace by, for example, dragging and dropping a worker object from worker objects panel 712 to a workspace object represented on worker assignment panel 711. In some implementations, worker objects panel 712 may provide unassigned workers. In some implementations, user selection of a worker object on worker objects panel 712 and/or worker assignment panel 711 may cause worker attributes panel 713 and/or worker list panel 714 to display worker attributes associated with the selected worker object.

Worker attributes panel 713 may display one or more worker attributes associated with a worker (e.g., a selected worker object). In some implementations, user device 210 may receive, from administrative device 220, information identifying worker attributes associated with a worker, and may display the identified worker attributes in worker attributes panel 713. Additionally, or alternatively, the user may edit worker attributes associated with a worker by editing information displayed in worker attributes panel 713.

Worker list panel 714 may display one or more worker attributes associated with one or more workers, and may provide an input mechanism (e.g., a button, a drop down list, a text box, a search box, etc.) for a user to search, sort, and/or filter the displayed information, in a manner similar to the manner described in connection with workspace list panel 516. In some implementations, worker list panel 714 may display multiple workers as being associated with one workspace. The workers displayed in worker list panel 714 may be associated with a selected location and/or floor plan (e.g., a floor plan displayed on worker assignment panel 711).

FIG. 7C shows an example user interface 720 that may correspond to user interface 710 (FIG. 7B), and may include tab section 501, floor plan selection mechanism 512, worker assignment panel 711, worker objects panel 712, worker attributes panel 713, and worker list panel 714. User interface 720 may provide a mechanism for a user to assign workers to workspaces.

As shown in FIG. 7C, a user may interact with floor plan selection mechanism 512 to select an existing floor plan associated with the third floor of the building at 255 Parkshore Drive on the Folsom campus. Based on the user selection, user interface 720 may provide the existing floor plan (e.g., previously created and/or saved) in worker assignment panel 711. In some implementations, user device 210 may receive the existing floor plan from administrative device 220.

User interface 720 may display, in worker assignment panel 711, one or more workspaces associated with the selected floor plan. Additionally, or alternatively, user interface 720 may provide information about worker objects associated with the workspaces. As shown by reference number 721, user interface 720 may provide information identifying a worker named Melissa as being associated with a workspace displayed by worker assignment panel 711. Additionally, or alternatively, user interface 720 may display other worker information, worker attributes, and/or indications associated with a worker object and/or workspace object (e.g., as discussed herein in connection with FIG. 5E).

As shown by reference number 722, the user may interact with user interface 720 to assign a worker to a workspace. For example, the user may drag and drop a worker object, associated with a worker named Andrew, from worker objects panel 712 to a workspace object, identified as cubicle 723, represented on worker assignment panel 711. Additionally, or alternatively, the user may select Andrew from worker objects panel 712, may select cubicle 723, and may interact with assignment button 724 to assign Andrew to cubicle 723. In some implementations, user device 210 may receive, from administrative device 220, information that identifies a workspace to which a worker is assigned, and user device 210 may only permit a user to assign the worker to the identified workspace.

When a worker is assigned to a workspace, user device 210 may remove information that identifies the worker from worker objects panel 712 (e.g., may remove Andrew's name from worker objects panel 712). Additionally, or alternatively, when a worker is assigned to a workspace, user device 210 may add information that identifies the worker to the workspace to which the user is assigned (e.g., cubicle 723 in worker assignment panel 711). In some implementations, worker list panel 714 may display information (e.g., worker attributes) associated with a worker object that is assigned to a workspace object displayed in worker assignment panel 711.

User device 210 may assign the worker to the workspace, for example, by associating, in a data structure, information that identifies the worker (e.g., a worker identifier, a worker name, etc.) and information that identifies the workspace (e.g., a workspace identifier, a room number, etc.). Additionally, or alternatively, user device 210 may transmit, to administrative device 220, information that identifies the assignment, and administrative device 220 may associate, in a data structure, information that identifies the worker and information that identifies the workspace.

As shown by reference number 725, worker attributes panel 713 may display worker attributes associated with a selected worker object. For example, worker attributes panel 713 may identify a worker name (e.g., Andrew), a worker supervisor (e.g., Jeff), a worker type (e.g., employee, contractor, etc.), a worker job title (e.g., information technology worker, salesperson, etc.), worker contact information (e.g., a phone number, an email address, etc.), workspace attributes of a workspace associated with the worker (e.g., a workspace type, a workspace availability status, a phone jack, a mail drop, etc.), and/or other worker attributes associate with the selected worker object. In addition, worker attributes panel 713 may provide an image of the worker.

Additionally, or alternatively, user device 210 may highlight the selected worker object in worker list panel 714, and may provide worker attributes associated with the selected worker in worker list panel 714, as shown by reference number 726. Similarly, user selection of a worker object in worker list panel 714 may cause user device 210 to highlight the worker object in worker assignment panel 711, and/or may cause user device 210 to provide worker attributes associated with the selected worker in worker attributes panel 713.

As shown by reference number 727, user interface 720 may provide an indication of whether a workspace is activated or deactivated, and may provide a mechanism for the user to activate or deactivate a workspace (e.g., activate/deactivate button 545, described herein in connection with FIG. 5E). User device 210 may display an error message if a user attempts to assign a worker to a deactivated workspace.

Save assignments button 728 may provide an input mechanism (e.g., a button, a tab, a link, a menu item, etc.) for a user to save the assignments of workers to workspaces. For example, user selection of save assignments button 728 may cause user device 210 to save the worker assignment provided in worker assignment panel 711. The saved worker assignments may be associated with a location and/or a floor plan so that the saved worker assignments may be easily retrieved by a user. Additionally, or alternatively, user device 210 may transmit information that identifies the saved worker assignments to administrative device 220 for storage.

FIG. 7D shows an example user interface 730 that may correspond to user interface 720 (FIG. 7C), and may include tab section 501, floor plan selection mechanism 512, worker assignment panel 711, worker objects panel 712, worker attributes panel 713, and worker list panel 714. User interface 730 may provide a mechanism for a user to remove a worker assignment from a workspace.

As shown by reference number 731, the user may interact with user interface 730 to remove a worker assignment from a workspace. For example, the user may drag and drop a worker object, associated with a worker named Melissa, from a workspace object represented on worker assignment panel 711, identified as cubicle 732, to worker objects panel 712. Additionally, or alternatively, the user may select Melissa and/or cubicle 732 (e.g., via worker assignment panel 711 and/or worker list panel 714), and user device 210 may highlight cubicle 732 on user interface 730, as shown by reference number 733. The user may interact with remove worker button 734 to remove an assignment that associates Melissa with cubicle 732.

When a worker assignment is removed from a workspace, user device 210 may add information that identifies the worker to worker objects panel 712 (e.g., may add Melissa's name to worker objects panel 712). Additionally, or alternatively, when a worker assignment is removed from a workspace, user device 210 may remove information that identifies the worker from a workspace with which the user was previously assigned (e.g., cubicle 732 in worker assignment panel 711). In some implementations, user device 210 may remove information, associated with the removed worker object, from worker list panel 714.

User device 210 may remove an assignment between a worker and a workspace, for example, by removing an association, in a data structure, between information that identifies the worker (e.g., a worker identifier, a worker name, etc.) and information that identifies the workspace (e.g., a workspace identifier, a room number, etc.). Additionally, or alternatively, user device 210 may transmit, to administrative device 220, information that identifies the removed assignment, and administrative device 220 may remove an association, in a data structure, between information that identifies the worker and information that identifies the workspace.

As shown by reference number 735, user selection of Melissa may cause user device 210 to provide worker attributes, associated with Melissa, in worker attributes panel 713. Additionally, or alternatively, as shown by reference number 736, user selection of Melissa may cause user device 210 to provide worker attributes, associated with Melissa, in worker list panel 714.

FIG. 7E shows an example user interface 740 that may correspond to user interface 720 (FIG. 7C), and may include tab section 501, floor plan selection mechanism 512, worker assignment panel 711, worker objects panel 712, worker attributes panel 713, and worker list panel 714. User interface 740 may provide a mechanism for a user to re-assign a worker to a different workspace.

As shown in FIG. 7E, a worker named Andrew may be assigned to cubicle 741, and a worker named Melissa may be assigned to cubicle 742. As shown by reference number 743, the user may interact with user interface 740 to re-assign a worker to a different workspace. For example, the user may drag and drop a worker object, associated with Andrew, from a first workspace object represented on worker assignment panel 711, identified as cubicle 741, to a second workspace object represented on worker assignment panel 711, identified as cubicle 742.

In some implementations, the second workspace to which the worker is re-assigned may be unoccupied, may be partially occupied, and/or may have work stations available. In this example, user device 210 may assign the worker to the second workspace, and user device 210 may remove an assignment between the worker and the first workspace.

Alternatively, the second workspace to which the worker is re-assigned may be partially occupied, fully occupied, and/or may not have work stations available. In this example, user device 210 may prompt the user (e.g., on user interface 740) as to whether the user wishes to switch workers between the first workspace and the second workspace, or replace the worker in the second workspace with the worker from the first workspace.

If the user selects to switch the workers, then an assignment between Melissa (or another worker, associated with the cubicle, and selected by the user) and cubicle 742 may be removed, an assignment between Andrew and cubicle 741 may be removed, Andrew may be assigned to cubicle 742, and Melissa may be assigned to cubicle 741. If the user selects to replace the worker in the second workspace, then an assignment between Melissa and cubicle 742 may be removed, Melissa may be identified in worker objects panel 712 as being unassigned, and Andrew may be assigned to cubicle 742.

In some implementations, when a worker is assigned to a workspace, removed from a workspace assignment, or re-assigned from a first workspace to a second workspace, user device 210 may update assignment information associated with the worker and/or workspace(s), and/or may provide the assignment information to administrative device 220 to update information associated with the worker and/or the workspace(s). Additionally, or alternatively, user device 210 may update information displayed by worker attributes panel 713 and/or worker list panel 714.

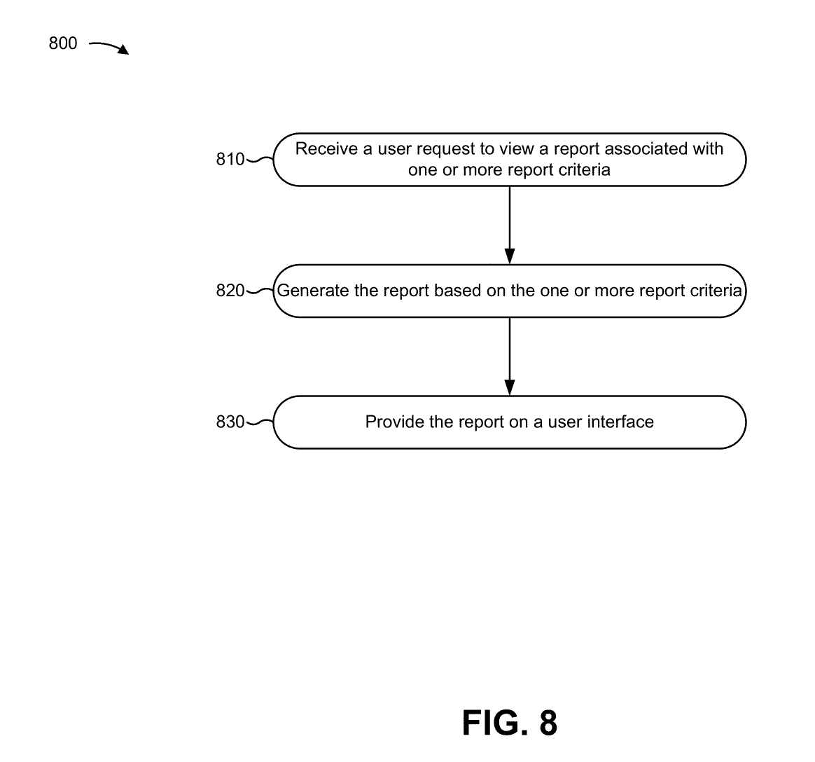

FIG. 8 is a flow chart of an example process 800 for generating and providing a report associated with a floor plan. In some implementations, one or more process blocks of FIG. 8 may be performed by user device 210. Additionally, or alternatively, one or more process blocks of FIG. 8 may be performed by another device or a group of devices separate from or including user device 210, such as administrative device 220.

As shown in FIG. 8, process 800 may include receiving a user request to view a report associated with one or more report criteria (block 810). For example, user device 210 may receive, via a user interface, a user request for a report. The user request may identify one or more report criteria, such as one or more locations, floor plans, workspace objects, workspace attributes, worker objects, worker attributes, etc.

As further shown in FIG. 8, process 800 may include generating the report based on the one or more report criteria (block 820), and providing the report on a user interface (block 830). In some implementations, user device 210 may generate the report, and may provide the report on a user interface of user device 210. Additionally, or alternatively, administrative device 220 may receive information from one or more user devices 210, may generate the report based on the received information, and may provide the report to user device 210 for display on the user interface of user device 210.

While a series of blocks has been described with regard to FIG. 8, the blocks and/or the order of the blocks may be modified in some implementations. Additionally, or alternatively, non-dependent blocks may be performed in parallel.

FIG. 9A shows an example user interface 900 that may correspond to user interface 500 (FIG. 5A), and may include tab section 501, summary section 502, and summary selection panel 503. In some implementations, a user may navigate to a reports tab 901 in tab section 501, which may cause user device 210 to provide user interface 910 of FIG. 9B.

FIG. 9B shows an example user interface 910 that provides a mechanism for a user to request and/or view a report. In some implementations, user interface 910 may be displayed when the user selects reports tab 901 (FIG. 9A). As shown in FIG. 9B, user interface 910 may include tab section 501, a report selection mechanism 911, a report list panel 912, a report filter panel 913, a report description panel 914, and a report display panel 915.

Report selection mechanism 911 may provide a mechanism (e.g., a tab, a link, a menu item, etc.) for a user to select a report for display in report display panel 915. In some implementations, report selection mechanism 911 may display a representation of previously generated reports. For example, a user may select a report via report list panel 912, and the selected report may be accessible via a tab on report selection mechanism 911. In some implementations, report selection mechanism 911 may provide access to a particular quantity (e.g., ten) of previously generated reports.

Report list panel 912 may provide a list of reports for a user to select (e.g., based on report criteria), and may provide a mechanism (e.g., a button, a link, etc.) that causes user device 210 to display a selected report in report display panel 915. In some implementations, a user may drag and drop a report from report list panel 912 to report display panel 915, causing user device 210 to display the report on report display panel 915, and causing user device 210 to create a tab for the report on report selection mechanism 911. Report list panel 912 may provide one or more workspace reports (e.g., assigned workspaces, unassigned workspaces, occupied workspaces, partially occupied workspaces, fully occupied workspaces, available workspaces, activated workspaces, deactivated workspaces, workspaces associated with a particular workspace attribute and/or worker attribute, etc.) and/or one or more worker reports (e.g., assigned workers, unassigned workers, workers associated with a particular worker attribute and/or workspace attribute, etc.).

Report filter panel 913 may provide a mechanism (e.g., a drop down box, a list box, a check box, a text box, a button, etc.) for a user to input one or more report criteria to filter information displayed in report display panel 915. User device 210 may filter the report based on any information described herein as being associated with a floor plan, a workspace, a workspace object, a worker, and/or a worker object. For example, user device 210 may filter the report to display information associated with an available workspace, a particular location, a particular floor plan, a particular cost center (e.g., a department) of an enterprise, a worker type (e.g., all workers, employees, contractors, etc.), a particular job description or job title, etc. The user may input the report criteria, and user device 210 may display information associated with the report criteria in report display panel 915.

Report description 914 may display information that describes a report selected in report list panel 912, associated with report criteria selected in report filter panel 913, and/or displayed in report display panel 915.

Report display panel 915 may display information associated with a report selected via report selection mechanism 911 and/or report list panel 912, and/or associated with report criteria selected in report filter panel 913. For example, report display panel 915 may display information associated with unassigned employees, as shown. The displayed information may include, for example, a worker type (e.g., employee), a name of a supervisor (e.g., Sam Madison), a name of an unassigned worker (e.g., Brian Smith), a cost center or department (e.g., 4600), a job description (e.g., senior programmer analyst), etc. associated with an unassigned worker. In some implementations, the displayed information may be searched, sorted, and/or filtered (e.g., in a manner similar to the manner described in connection with workspace list panel 516, FIG. 5F). Additionally, or alternatively, a report may be saved, named, exported, made public or private, etc.

In some implementations, the user may interact with information displayed in report display panel 915, and user device 210 may provide at least one of user interfaces 710-740, and may provide, on the user interface, information based on the user interaction. For example, a user may select an unassigned worker, and user device 210 may display the unassigned worker in worker objects panel 712, and may display a floor plan associated with the unassigned worker in worker assignment panel 711.

FIG. 9C shows an example user interface 920 that may correspond to user interface 910 (FIG. 9B), and may include tab section 501, report selection mechanism 911, report list panel 912, report filter panel 913, report description panel 914, and report display panel 915.

As shown in FIG. 9C, report display panel 915 may display a heat map. The heat map may provide information that identifies a quantity, a percentage, a ratio, etc. associated with a floor plan, a workspace, a workspace object, a worker, and/or a worker object. For example, the heat map may indicate a percentage of assigned or unassigned workers associated with one or more locations, floor plans, workspaces, workspace objects, workspace attributes, and/or worker attributes (e.g., cost center, worker type, etc.). For example, the heat map may indicate that 30% of the workers at campus A are unassigned, and 10% of the workers at campus B are unassigned. The heat map may represent the difference in percentages using different colors.

In some implementations, the user may interact with the representation of campus A, and report display panel 915 may provide a report that identifies unassigned workers at campus A. Additionally, or alternatively, based on the user interaction, user device 210 may provide at least one of user interfaces 710-740, and may provide, in worker assignment panel 711, a floor plan associated with campus A and a list of unassigned workers, in worker objects panel 712, associated with campus A.

As another example, the heat map may indicate a percentage of assigned, unassigned, occupied, available, etc. workspaces associated with one or more locations, floor plans, workspace attributes (e.g., window offices, obstructed offices, etc.), workers, worker objects, and/or worker attributes. For example, the heat map may indicate that 30% of work stations at campus A are available, and 10% of work stations at campus B are available. In some implementations, the user may interact with the representation of campus A, and report display panel 915 may provide a report that identifies available work stations at campus A.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term “component” is intended to be broadly construed as hardware, firmware, or a combination of hardware and software.

Certain user interfaces have been described herein. In some implementations, the user interfaces may be customizable by a user and/or a device. Additionally, or alternatively, the user interfaces may be pre-configured to a standard configuration, a specific configuration based on a type of device on which the user interfaces are displayed, or a set of configurations based on capabilities and/or specifications associated with a device on which the user interfaces are displayed.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A user device, comprising:
one or more processors to:
receive a first user request that identifies a floor plan;
provide, based on receiving the first user request, the floor plan on a first portion of a user interface;
receive, from an administrative device, first information that identifies a plurality of workspaces associated with the floor plan;
provide, on a second portion of the user interface and based on the first information, one or more workspace objects associated with the plurality of workspaces;
receive a first user selection of a particular workspace object, of the one or more workspace objects, and a portion of the floor plan; and
provide, based on the first user selection and on the first portion of the user interface associated with the selected portion of the floor plan, a representation of the particular workspace object.

2. The user device of claim 1, where the one or more processors are further to:
receive a second user request to assign a worker;
receive second information that identifies a plurality of unassigned workers associated with the floor plan;
provide, based on receiving the second user request and the second information, and on a third portion of the user interface, one or more worker objects associated with the plurality of unassigned workers;
receive a second user selection of a particular worker object, of the one or more worker objects, and a first workspace object represented on the first portion of the user interface;
associate the particular worker object with the first workspace object; and
provide, based on the second user selection and on the first portion of the user interface, an indication that the particular worker object is assigned to the first workspace object.

3. The user device of claim 2, where the one or more processors are further to:
remove, from the third portion of the user interface and based on associating the particular worker object with the first workspace object, information that identifies the particular worker object.

4. The user device of claim 2, where the one or more processors are further to:
receive a third user request to remove an assignment between an assigned worker object and an assigned workspace object;
remove an association between the assigned worker object and the assigned workspace object; and
provide, on the third portion of the user interface and based on removing the association, information that identifies the assigned worker object.

5. The user device of claim 2, where the one or more processors, when associating the particular worker object with the first workspace object, are further to at least one of:
associate, in a data structure accessible by the user device, the particular worker object and the first workspace object; or
transmit, to the administrative device, information that identifies the particular worker object and the first workspace object,
the information causing the administrative device to associate, in a data structure accessible by the administrative device, the particular worker object and the first workspace object.

6. The user device of claim 2, where the first user request identifies a location associated with the floor plan, and
where the plurality of unassigned workers are associated with the identified location.

7. The user device of claim 1, where the one or more processors are further to:
receive information that identifies a worker associated with an assigned workspace object, of the one or more workspace objects; and
provide, on the first portion of the user interface, an indication that the worker is associated with the assigned workspace object.

8. A computer-readable medium storing instructions, the instructions comprising:
one or more instructions that, when executed by a processor of a user device, cause the processor to:
receive location information that identifies a floor plan;
provide, based on receiving the location information, the floor plan on a first portion of a user interface;
receive, from an administrative device, first information that identifies a plurality of workspaces associated with the floor plan;
provide, on a second portion of the user interface and based on the first information, one or more workspace objects associated with the plurality of workspaces;
receive a first user selection of a particular workspace object, of the one or more workspace objects, and a portion of the floor plan; and
provide, based on the first user selection and on the first portion of the user interface associated with the selected portion of the floor plan, a representation of the particular workspace object.

9. The computer-readable medium of claim 8, where the one or more instructions further cause the processor to:
receive, from the administrative device, second information that identifies a plurality of unassigned workers associated with the floor plan;
provide, based on the second information and on a third portion of the user interface, one or more worker objects associated with the plurality of unassigned workers;
receive a second user selection of a particular worker object, of the one or more worker objects, and a first workspace object represented on the first portion of the user interface;
associate the particular worker object with the first workspace object; and
provide, based on the second user selection and on the first portion of the user interface, an indication that the particular worker object is assigned to the first workspace object.

10. The computer-readable medium of claim 9, where the one or more instructions further cause the processor to:
remove, from the third portion of the user interface and based on associating the particular worker object with the first workspace object, information that identifies the particular worker object.

11. The computer-readable medium of claim 9, where the one or more instructions further cause the processor to:
receive information that identifies an assigned worker object and an assigned workspace object;
remove an association between the assigned worker object and the assigned workspace object; and
provide, on the third portion of the user interface and based on removing the association, information that identifies the assigned worker object.

12. The computer-readable medium of claim 9, where the one or more instructions, that cause the processor to associate the particular worker object with the first workspace object, further cause the processor to at least one of:
associate, in a data structure accessible by the user device, the particular worker object and the first workspace object; or
transmit, to the administrative device, information that identifies the particular worker object and the first workspace object,
the information causing the administrative device to associate, in a data structure accessible by the administrative device, the particular worker object and the first workspace object.

13. The computer-readable medium of claim 8, where the one or more instructions further cause the processor to:
receive information that identifies a worker associated with an assigned workspace object, of the one or more workspace objects; and
provide, on the first portion of the user interface, an indication that the worker is associated with the assigned workspace object.

14. The computer-readable medium of claim 8, where the location information identifies at least one of:
a campus associated with the floor plan;
a building associated with the floor plan; or
a floor associated with the floor plan.

15. A method, comprising:
receiving, by a user device, information that identifies a floor plan;
providing, by the user device, the floor plan on a first portion of a user interface;
receiving, by the user device, first information that identifies a plurality of workspaces associated with the floor plan;
providing, by the user device, on a second portion of the user interface, and based on the first information, one or more workspace objects associated with the plurality of workspaces;
receiving, by the user device, a first user selection of a particular workspace object, of the one or more workspace objects, and a portion of the floor plan;
providing, by the user device, based on the first user selection, and on the first portion of the user interface associated with the selected portion of the floor plan, a representation of the particular workspace object;
receiving, by the user device, second information that identifies a plurality of unassigned workers associated with the floor plan;
providing, by the user device and based on the second information, and on a third portion of the user interface, one or more worker objects associated with the plurality of unassigned workers;
receiving, by the user device, a second user selection of a particular worker object, of the one or more worker objects, and a first workspace object represented on the first portion of the user interface;
associating, by the user device, the particular worker object with the first workspace object; and
providing, by the user device and on the first portion of the user interface, an indication that the particular worker object is assigned to the first workspace object, based on the second user selection.

16. The method of claim 15, further comprising:
removing, from the third portion of the user interface and based on associating the particular worker object with the first workspace object, information that identifies the particular worker object.

17. The method of claim 15, further comprising:
receiving a request to remove an assignment between an assigned worker object and an assigned workspace object;
removing an association between the assigned worker object and the assigned workspace object; and
providing, on the third portion of the user interface and based on removing the association, information that identifies the assigned worker object.

18. The method of claim 15, where associating the particular worker object with the first workspace object further comprises at least one of:
associating, in a data structure accessible by the user device, the particular worker object and the first workspace object; or
transmitting, to an administrative device, information that identifies the particular worker object and the first workspace object,
the information causing the administrative device to associate, in a data structure accessible by the administrative device, the particular worker object and the first workspace object.

19. The method of claim 15, where the information that identifies a floor plan further identifies a location associated with the floor plan, and
where the plurality of unassigned workers are associated with the identified location.

20. The method of claim 15, further comprising:
receiving information that identifies a worker associated with an assigned workspace object, of the one or more workspace objects; and
providing, on the first portion of the user interface, an indication that the worker is associated with the assigned workspace object.
